(19) United States
(12) Patent Application Publication
(10) Pub. No.: US 2014/0234769 A1
(43) Pub. Date: Aug. 21, 2014

(54) LIQUID DEVELOPER

(71) Applicant: Konica Minolta, Inc., Chiyoda-ku (JP)

(72) Inventors: Naoki YOSHIE, Ibaraki-shi (JP); Masahiro ANNO, Sakai-shi (JP); Keiko MOMOTANI, Ibaraki-shi (JP); Miyuki HOTTA, Kobe-shi (JP); Satoshi MATSUMOTO, Kyoto-shi (JP); Sho KIM, Kyoto-shi (JP); Yukiko UNO, Kyoto-shi (JP)

(73) Assignee: Konica Minolta, Inc., Chiyoda-ku (JP)

(21) Appl. No.: 14/184,752

(22) Filed: Feb. 20, 2014

(30) Foreign Application Priority Data
Feb. 21, 2013 (JP) 2013-032241

(51) Int. Cl. G03G 9/12

(52) U.S. Cl. CPC G03G 9/12
USPC 430/112

(57) ABSTRACT

A liquid developer includes an insulating liquid and a plurality of toner particles. The plurality of toner particles has a median size not smaller than 1 μm and not greater than 3 μm as a whole. In the plurality of toner particles, average circularity is not smaller than 0.90 and not greater than 0.96, and a standard deviation of circularity is not smaller than 0.02 and not greater than 0.10.

This application is based on Japanese Patent Application No. 2013-032241 filed with the Japan Patent Office on Feb. 21, 2013, the entire content of which is hereby incorporated by reference.

### BACKGROUND OF THE INVENTION

1. Field of the Invention

The present invention relates to a liquid developer.

2. Description of the Related Art

Various liquid developers have been known as a liquid developer (also called an aqueous developer) for use in an image formation apparatus of an electrophotography type. For example, Japanese Laid-Open Patent Publication No. 2012-113167 discloses a liquid developer including toner particles containing a core-shell type resin and having an average particle size of 1.1 μm coefficient of variation of 20%, and an average circularity of 0.98.

### SUMMARY OF THE INVENTION

In the liquid developer above, the toner particles are dispersed in an insulating liquid. As compared with a conventional dry developer, therefore, the particle size of the toner particles can be reduced to about 1 to 3 μm. Thus, the uniformity of images is enhanced, which leads to high image quality.

On the other hand, when the size of the toner particles is reduced as described above, the liquid developer has the following problem. That is, the mobility in an electric field is lowered, so that the transferability is degraded. Moreover, the toner particles having the small particle size are less prone to be subjected to cleaning using physical force, such as blade cleaning. In other words, the liquid developer has a problem that the cleanability is poor.

Herein, the form of the toner particles, particularly, the average circularity of the toner particles is known as a factor that affects the transferability and cleanability of the liquid developer. However, both the transferability and the cleanability cannot be improved even when only the average circularity is controlled. For example, when the average circularity is increased, the transferability is improved, but the cleanability is lowered. On the other hand, when the average circularity is decreased, the cleanability is improved, but the transferability is lowered. That is, in the case of controlling the average circularity, a trade-off relation is established between the transferability and the cleanability, so that both the transferability and the cleanability cannot be enhanced. Heretofore, there is no liquid developer having improved transferability and cleanability with the particle size of toner particles reduced to about 1 to 3 μm.

The present invention was made in view of such aspects, and an object thereof is to provide a liquid developer having excellent transferability and cleanability with the size of toner particles reduced.

The liquid developer includes an insulating liquid and a plurality of toner particles. The plurality of toner particles has a median size not smaller than 1 μm and not greater than 3 μm as a whole. In the plurality of toner particles, average circularity is not smaller than 0.90 and not greater than 0.96, and a standard deviation of circularity is not smaller than 0.02 and not greater than 0.10.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a schematic conceptual diagram of an image formation apparatus of an electrophotography type.

### DESCRIPTION OF THE PREFERRED EMBODIMENTS

First, description will be given of a summary of an embodiment of the present invention (hereinafter, the embodiment is also referred to as “the present embodiment”).

The present inventor has conducted dedicated studies in order to achieve the object above, and has gained the following finding. That is, with regard to a liquid developer including toner particles having a small particle size, controlling an average circularity of the toner particles and controlling distribution of circularity are effective at improving both the transferability and the cleanability of the liquid developer. The present inventor has invented the present invention by conducting further studies based on this finding over and over again. That is, the liquid developer of the present embodiment has the following constitutions.

(1) The liquid developer includes an insulating liquid and a plurality of toner particles. The plurality of toner particles has a median size not smaller than 1 μm and not greater than 3 μm as a whole. In the plurality of toner particles, average circularity is not smaller than 0.90 and not greater than 0.96, and a standard deviation of circularity is not smaller than 0.02 and not greater than 0.10.

(2) Preferably, the standard deviation of the circularity is not smaller than 0.05 and not greater than 0.10.

(3) Preferably, a minimum value of the circularity is not smaller than 0.85 times and not greater than 0.95 times the average circularity.

Hereinafter, more specific description will be given of the present embodiment; however, the present embodiment is not limited thereto.

<Liquid Developer>

The liquid developer of the present embodiment includes at least an insulating liquid and a plurality of toner particles. The toner particles are dispersed in the insulating liquid. The liquid developer may include any other components so long as it includes the components above. Examples of the other components may include a toner dispersant (a dispersant which is not a dispersant for pigment contained in the toner particle (such a dispersant for pigment will be described later), but is a dispersant contained in the insulating liquid in order to disperse the toner particles, and is referred to as “a toner dispersant” herein for convenience), a charge control agent, a thickener, and the like.

In the liquid developer, a blending ratio of the toner particles may be, for example, 10 to 50 mass %, and the remainder may be the insulating liquid and the like. When the blending ratio of the toner particles is lower than 10 mass %, the toner particles are prone to precipitate. This indicates that chronological stability upon long-term storage tends to be lowered. Moreover, the liquid developer is required to be supplied in large amount in order to obtain desired image density, which results in an increase of the amount of the insulating liquid attached to a recording material such as paper. As a result, the insulating liquid is required to be dried at the time of fixing, and an environmental problem may arise because of vapor generated from the dried insulating liquid. On the other hand, when the blending ratio of the toner particles exceeds 50 mass %, the viscosity of the liquid developer becomes too much high. This indicates that the liquid developer tends to be manufactured and handed with difficulty.

The liquid developer is useful as a developer for an image formation apparatus of an electrophotography type. More specifically, the liquid developer may be used as a liquid developer for electrophotography, which is used in an image formation apparatus of an electrophotography type such as a copier, a printer, a digital printing machine, or a simplified printing machine, a paint, a liquid developer for electrostatic recording, an oil-based ink for an ink jet printer, an ink for electronic paper, or the like.

<Toner Particles>

In the liquid developer of the present embodiment, the toner particle contains a resin and a coloring agent dispersed in the resin. The toner particle may contain any other components so long as it contains the components above. Examples of the other components may include a dispersant for pigment, a wax, a charge control agent, and the like. A blending ratio between the resin and the coloring agent may be set such that a desired concentration is obtained when the toner particles are applied in a desired attachment amount. For example, the blending ratio of the resin may be preferably 50 to 95 mass %, more preferably 60 to 80 mass %. When the blending ratio of the resin is lower than 50 mass %, bonding force between the toner particles becomes weakened. As a result, a fixation strength may become poor. When the blending ratio of the resin exceeds 95 mass %, a concentration of the coloring agent becomes too much low in a case of achieving a low attachment amount for obtaining a print-like image. As a result, a desired color tone may be less prone to be realized.

In the liquid developer of the present embodiment, the plurality of toner particles has the median size not smaller than 1 μm and not greater than 3 μm as a whole. The median size herein means such a particle size that an accumulated volume becomes 50% at the time of measuring a projected area diameter of the particle with regard to the plurality of particles (a diameter of a circle having an area which is equal to an area of a two-dimensionally projected particle) and obtaining accumulative distribution (volumetric distribution) on a volume basis. The median size is typically called D50, and herein is a value obtained from calculation after the particle is sensed optically.

Moreover, the phrase “as a whole” means a median size directed to all the toner particles contained in the liquid developer.

As described above, the liquid developer of the present embodiment includes the toner particles having the smaller particle size than that of toner particles used in a conventional dry developer. Thus, the uniformity of images is enhanced, which leads to high image quality. When the median size is smaller than 1 μm, the mobility in an electric field is degraded because the particle size is too much small, so that developability may be lowered. When the median size exceeds 3 μm, the uniformity is degraded, so that image quality may be lowered. The median size is more preferably not smaller than 1.2 μm and not greater than 2.5 μm.

In the liquid developer of the present embodiment, the plurality of toner particles has the average circularity (an average value of circularity) not smaller than 0.90 and not greater than 0.96, and the standard deviation of the circularity not smaller than 0.02 and not greater than 0.10.

The toner particles satisfy the conditions above, to thereby produce such an effect that the liquid developer is excellent in both transferability and cleanability even when the median size of the toner particles is not smaller than 1 μm and not greater than 3 μm. Moreover, the liquid developer can also realize high image quality because the toner particles have the small particle size as described above.

The average circularity, which is smaller than 0.90, is not preferable because the transferability tends to be degraded. The average circularity, which exceeds 0.96, is also not preferable because the cleanability tends to be lowered. The average circularity is more preferably not smaller than 0.91 and not greater than 0.95.

When the standard deviation of the circularity is smaller than 0.02, the cleanability is degraded. The reason therefor is considered as follows. That is, amorphous particles contained in the toner particles serve as an origin point of contact between a blade and the particles at the time when the blade scrapes the toner particles off. In other words, when the standard deviation of the circularity is smaller than 0.02, the number of amorphous particles in the toner particle is extremely small, so that blade cleaning is less prone to be conducted.

On the other hand, when the standard deviation of the circularity exceeds 0.10, the stable developing and transferring are less prone to be conducted. The reason therefor is considered as follows. That is, the number of amorphous particles contained in the toner particles is excessively large. When the ratio of the amorphous particles is high (i.e., when there are large variations in particle form), toner having high circularity is preferentially consumed and toner having low circularity remains at the time of developing. A so-called screening phenomenon occurs. Therefore, the entire circularity of the toner particles varies each time the developing and transferring, so that the developability and the transferability become unstable, and a concentration is changed.

The standard deviation of the circularity is preferably not smaller than 0.05 and not greater than 0.10. The standard deviation of the circularity, which falls within this range, is preferable because the transferability and the cleanability can be further enhanced.

Moreover, the minimum value of the circularity is preferably not smaller than 0.85 times and not smaller than 0.95 times the average circularity. The minimum value of the circularity, which is smaller than 0.85 times the average circularity, is not preferable because the liquid developer includes particles which are extremely different in form from one another as compared with normal particles, so that the transferability may be degraded. On the other hand, the minimum value of the circularity, which exceeds 0.95 times the average circularity, is not preferable because the ratio of particles serving as an origin point where the blade scrapes toner off becomes short, so that the cleanability may be degraded. The minimum value of the circularity is more preferably not smaller than 0.87 times and not greater than 0.93 times the average circularity.

The circularity above indicates a numeric value obtained by dividing a circumferential length of a circle having an area which is equal to an area of a two-dimensionally projected particle, by a circumferential length of a particle. This value is obtained from calculation after the particle is sensed optically. “The average circularity”, “the standard deviation of the circularity”, and “the minimum value of the circularity” indicate “an average value (an arithmetic mean value)”, “a standard deviation”, and “a minimum value” each obtained from a cluster of circularity which is obtained by measuring the circularity of the plurality of particles. From a point of view of reliability of measurement, preferably, the average value and the standard deviation are calculated on the basis of the result of measurement on not smaller than 100 toner particles.

In the present embodiment, “the average circularity”, “the standard deviation of the circularity”, and “the minimum value of the circularity” are values measured in a state that the toner particles are dispersed in the insulating liquid serving as a carrier liquid. Heretofore, the circularity of the toner particles, and the like have adopted a value measured in a state that a liquid developer is dried once, and then is dispersed in water or the like. The values to be adopted in the liquid developer of the present embodiment are measured in a state close to the dispersed state at the time when the liquid developer is actually used. Thus, new aspects are found with regard to a relation between the circularity or the like and the transferability and cleanability, which has not been confirmed.

That is, even when the value measured in the insulating liquid is equal to the value measured in the aqueous dispersing medium, these values should be considered as being substantially different from each other.

The insulating liquid serving as a flow solvent used at the time of measurement is preferably equal to the insulating liquid of the liquid developer. At the time of measurement, the liquid developer may be used as it is, or the liquid developer may be used in such a manner that a concentration is appropriately adjusted, e.g., the liquid developer is diluted with the insulating liquid.

The measurement in the insulating liquid may be performed with the use of a flow particle image analyzer (trade name: “FPIA-3000S” manufactured by SYSMEX CORPORATION) or the like. This apparatus is preferably because the insulating liquid can be used as a dispersing medium without any change. This apparatus is also capable of measuring the median size above, and the a case function of this apparatus allows the calculation of the average circularity, the standard deviation of the circularity, and the minimum value of the circularity.

<Method for Manufacturing Toner Particles>

In the present embodiment, the toner particles may be manufactured on the basis of a conventionally known technique such as a granulating method or a crushing method, by controlling the conditions.

The crushing method involves melting and kneading a resin and a coloring agent such as a pigment in advance, and then crushing a mixture thus obtained. This crush can be conducted in a dry state or in a wet state using the insulating liquid.

Examples of the granulating method may include a suspension polymerization method, an emulsion polymerization method, a fine particle aggregation method, a method of adding a poor solvent to a resin solution and precipitating the resin, a spray dry method, and the like in view of a difference of a formation mechanism of the toner particles. In particular, preferably, a method of manufacturing the toner particles having, as a resin constitution, a core-shell structure including two different resins is used in order to realize the form and particle size of the toner particles of the present embodiment. After the manufacturing of the toner particles, heat treatment such as annealing may be conducted out if necessary in order to align resin molecules.

The method of manufacturing the toner particles of the present embodiment is not particularly limited so long as it can achieve the form and particle size of the toner particles. The granulating method rather than the crushing method is preferably adopted. In particular, the core-shell structure above is preferably adopted as the resin constitution. With regard to the crushing method, when a wet crushing method is adopted, the form of the particle is apt to be planar because of shearing, so that toner particles having high circularity are less prone to be manufactured. On the other hand, when a dry crushing method is adopted, toner particles having a small particle size are less prone to be manufactured. That is, even when any one of the dry method and the wet method is adopted, toner particles having the desired form and particle size are less prone to be manufactured.

Contrary to this, the granulating method allows stable manufacturing of toner particles having the desired form and particle size, by controlling the various conditions. Particularly, a resin is dissolved in a good solvent to form a core resin solution, and the core resin solution is mixed, together with an interfacial tension adjustor, into a poor solvent having a different SP value (to be described later) from that of the good solvent and also having a higher boiling point than that of the good solvent to form a droplet by shearing. Thereafter, the good solvent is volatilized to form core resin fine particles. Then, shell resin fine particles are used as the interfacial tension adjustor such that the surfaces of the core resin fine particles are coated with the shell resin fine particles. Thus, the toner particles of which the circularity is controlled within a specific distribution can be manufactured in a considerably stable manner. In this method, a surfactant, a dispersant or the like may be used as the interfacial tension adjustor.

This method is preferable because the shearing method, the difference in interfacial tension, or the interfacial tension adjustor (the shell resin fine particles) is appropriately adjusted, to thereby control the particle size and form of the toner particle with high accuracy. For example, the shell resin fine particles are preferably used as the interfacial tension adjustor because the control can be further enhanced. The reason therefor is estimated as follows. That is, the shell resin fine particles serve as a coating, so that the specific particle size and form in the present embodiment are achieved with ease upon volatilization of the good solvent.

Also in this method, further, the particle size and form change because of the type of a resin to be dissolved in the good solvent. A resin having high crystallinity is preferably used because the specific particle size and form in the present embodiment can be achieved with ease, as compared with a resin having low crystallinity.

Although the details of a reason are not clear at this stage, when a basic dispersant is used as the dispersant for pigment, there is a tendency to readily obtain toner particles in which the median size is not smaller than 1 μm and not greater than 3 μm, the average circularity is not smaller than 0.90 and not greater than 0.96, and the standard deviation of circularity is not smaller than 0.02 and not greater than 0.10. Accordingly, the method of using the basic dispersant as the dispersant for pigment is a particularly preferable method.

The liquid developer of the present embodiment may be manufactured in such a manner that the toner particles manufactured as described above are dispersed in the insulating liquid. In a case where the toner particles are manufactured in the insulating liquid, the resultant mixture may be directly used as the liquid developer.

<Resin>

As a resin contained in the toner particles of the present embodiment, a conventionally known resin for use in the application of this type may be used without specific limitations. Examples of the resin may include a resin having a core-shell structure such that shell particles (A) containing a shell resin (a) are attached to or cover surfaces of core particles (B) containing a core resin (b). Hereinafter, this core-shell resin will be described.

<Shell Resin (a)>

The shell resin (a) of the present embodiment may be a thermoplastic resin or a thermosetting resin. Examples of the shell resin (a) may include a vinyl resin, a polyester resin, a polyurethane resin, an epoxy resin, a polyamide resin, a polyimide resin, a silicon resin, a phenol resin, a melamine resin, a urea resin, an aniline resin, an ionomer resin, a polycarbonate resin, and the like. Two or more of these may be used together as the shell resin (a).

From a point of view of ease in obtaining the toner particles in the form of the present embodiment with ease, the shell resin (a) is preferably at least one of a vinyl resin, a polyester resin, a polyurethane resin, and an epoxy resin, and more preferably at least one of a polyester resin and a polyurethane resin.

<Vinyl Resin>

A vinyl resin may be a homopolymer obtained by homopolymerizing a monomer having polymeric double bond (a homopolymer containing a bonding unit derived from a vinyl monomer) or a copolymer obtained by copolymerizing two or more types of monomers having polymeric double bond (a copolymer containing a bonding unit derived from a vinyl monomer). Examples of a monomer having polymeric double bond may include (1) to (9) below.

(1) Hydrocarbon Having Polymeric Double Bond

Hydrocarbon having polymeric double bond is preferably, for example, aliphatic hydrocarbon having polymeric double bond shown in (1-1) below, aromatic hydrocarbon having polymeric double bond shown in (1-2) below, or the like.

(1-1) Aliphatic Hydrocarbon Having Polymeric Double Bond

Aliphatic hydrocarbon having polymeric double bond is preferably, for example, chain hydrocarbon having polymeric double bond shown in (1-1-1) below, cyclic hydrocarbon having polymeric double bond shown in (1-1-2) below, or the like.

(1-1-1) Chain Hydrocarbon Having Polymeric Double Bond

Examples of chain hydrocarbon having polymeric double bond may include alkene having a carbon number from 2 to 30 (such as ethylene, propylene, butene, isobutylene, pentene, heptene, diisobutylene, octene, dodecene, or octadecene), alkadiene having a carbon number from 4 to 30 (such as butadiene, isoprene, 1,4-pentadiene, 1,5-hexadiene, or 1,7-octadiene), and the like.

(1-1-2) Cyclic Hydrocarbon Having Polymeric Double Bond

Examples of cyclic hydrocarbon having polymeric double bond may include mono- or di-cycloalkene having a carbon number from 6 to 30 (such as cyclohexene, vinyl cyclohexene, or ethylidene bicycloheptene), mono- or di-cycloalkadiene having a carbon number from 5 to 30 (such as monocyclopentadiene or dicyclopentadiene), and the like.

(1-2) Aromatic Hydrocarbon Having Polymeric Double Bond

Examples of aromatic hydrocarbon having polymeric double bond may include styrene, a hydrocarbyl (such as alkyl, cycloalkyl, aralkyl, and/or alkenyl having a carbon number from 1 to 30) substitute of styrene (such as α-methylstyrene, vinyl toluene, 2,4-dimethylstyrene, ethylstyrene, isopropylstyrene, butylstyrene, phenylstyrene, cyclohexylstyrene, benzylstyrene, crotylbenzene, divinyl benzene, divinyl toluene, divinyl xylene, or trivinyl benzene), vinyl naphthalene, and the like.

(2) Monomer Having Carboxyl Group and Polymeric Double Bond and Salt Thereof

Examples of a monomer having a carboxyl group and polymeric double bond may include unsaturated monocarboxylic acid having a carbon number from 3 to 15 [such as (meth)acrylic acid, crotonic acid, isocrotonic acid, or cinnamic acid], unsaturated dicarboxylic acid (unsaturated dicarboxylic anhydride) having a carbon number from 3 to 30 [such as maleic acid (maleic anhydride), fumaric acid, itaconic acid, citraconic acid (citraconic anhydride), or mesaconic acid], monoalkyl (having a carbon number from 1 to 10) ester of unsaturated dicarboxylic acid having a carbon number from 3 to 10 (such as maleic acid monomethyl ester, maleic acid monodecyl ester, fumaric acid monoethyl ester, itaconic acid monobutyl ester, or citraconic acid monodecyl ester), and the like. “(Meth)acrylic acid” herein means acrylic acid and/or methacrylic acid.

Examples of salt of the monomer above may include alkali metal salt (such as sodium salt or potassium salt), alkaline earth metal salt (such as calcium salt or magnesium salt), ammonium salt, amine salt, quaternary ammonium salt, and the like.

Amine salt is not particularly limited so long as it is salt of an amine compound. Examples of amine salt may include primary amine salt (such as ethylamine salt, butylamine salt, or octylamine salt), secondary amine salt (such as diethylamine salt or dibutylamine salt), tertiary amine salt (such as triethylamine salt or tributylamine salt), and the like.

Examples of quaternary ammonium salt may include tetraethyl ammonium salt, triethyl lauryl ammonium salt, tetrabutyl ammonium salt, tributyl lauryl ammonium salt, and the like.

Examples of salt of the monomer having a carboxyl group and polymeric double bond may include sodium acrylate, sodium methacrylate, monosodium maleate, disodium maleate, potassium acrylate, potassium methacrylate, monopotassium maleate, lithium acrylate, cesium acrylate, ammonium acrylate, calcium acrylate, aluminum acrylate, and the like.

(3) Monomer Having Sulfo Group and Polymeric Double Bond and Salt Thereof

Examples of a monomer having a sulfo group and polymeric double bond may include alkene sulfonic acid having a carbon number from 2 to 14 [such as vinyl sulfonic acid, (meth)allyl sulfonic acid, or methyl vinyl sulfonic acid], styrene sulfonic acid, styrene sulfonic acid and an alkyl (having a carbon number from 2 to 24) derivative of styrene sulfonic acid (such as α-methylstyrene sulfonic acid), sulfo(hydroxy)alkyl-(meth)acrylate having a carbon number from 5 to 18 [such as sulfopropyl(meth)acrylate, 2-hydroxy-3-(meth)acryloxy propylsulfonic acid, 2-(meth)acryloyloxyethane sulfonic acid, or 3-(meth)acryloyloxy-2-hydroxypropane sulfonic acid], sulfo(hydroxy)alkyl(meth)acrylamide having a carbon number from 5 to 18 [such as 2-(meth)acryloylamino-2,2-dimethylethane sulfonic acid, 2-(meth)acrylamide-2-methylpropane sulfonic acid, or 3-(meth)acrylamide-2-hydroxypropane sulfonic acid], alkyl (having a carbon number from 3 to 18) allylsulfo succinic acid (such as propylallylsulfo succinic acid, butylallylsulfo succinic acid, or 2-ethylhexyl-allylsulfo succinic acid), poly-[n (“n” representing a degree of polymerization; to be understood similarly hereinafter)=2 to 30] oxyalkylene (such as oxyethylene, oxypropylene, or oxybutylene, polyoxyalkylene may be a homopolymer of oxyalkylene or a copolymer of oxyalkylene; if polyoxyalkylene is a copolymer of oxyalkylene, it may be a random polymer or a block polymer), sulfate ester of mono(meth)acrylate [such as sulfate ester of poly- (n=5 to 15) oxyethylene monomethacrylate or sulfate ester of poly- (n=5 to 15) oxypropylene monomethacrylate], a compound expressed with Chemical Formulae (1) to (3) below, and the like. “(Meth)allyl” herein means “allyl and/or methallyl”. “(Meth)acrylo” herein means “acrylo and/or methacrylo”. “(Meth)acrylate” herein means “acrylate and/or methacrylate”.

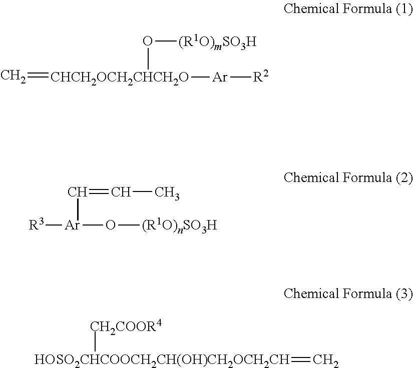

In Chemical Formulae (1) to (3) above, R¹ represents an alkylene group having a carbon number from 2 to 4. When Chemical Formula (1) includes two or more R¹Os, two or more R¹Os may be composed of the same alkylene group or of two or more types of alkylene groups as combined. When two or more types of alkylene groups are used as combined, a sequence of R¹ in Chemical Formula (1) may be a random sequence or a block sequence. R² and R³ each independently represent an alkyl group having a carbon number from 1 to 15. m and n are each independently an integer from 1 to 50. Ar represents a benzene ring. R⁴ represents an alkyl group having a carbon number from 1 to 15, which may be substituted with a fluorine atom.

Examples of salt of a monomer having a sulfo group and polymeric double bond may include salts listed as the “salt of the monomer above” in “(2) Monomer Having Carboxyl Group and Polymeric Double Bond and Salt Thereof” above.

(4) Monomer Having Phosphono Group and Polymeric Double Bond and Salt Thereof

Examples of a monomer having a phosphono group and polymeric double bond may include (meth)acryloyloxy alkyl phosphate monoester (a carbon number of an alkyl group being from 1 to 24) [such as 2-hydroxyethyl(meth)acryloyl phosphate or phenyl-2-acryloyloxy ethyl phosphate], (meth)acryloyloxy alkyl phosphonic acid (a carbon number of an alkyl group being from 1 to 24) (such as 2-acryloyloxy ethyl phosphonic acid), and the like.

Examples of salt of the monomer having a phosphono group and polymeric double bond may include salts listed as the “salt of the monomer above” in “(2) Monomer Having Carboxyl Group and Polymeric Double Bond and Salt Thereof” above.

(5) Monomer Having Hydroxyl Group and Polymeric Double Bond

Examples of a monomer having a hydroxyl group and polymeric double bond may include hydroxystyrene, N-methylol(meth)acrylamide, hydroxyethyl(meth)acrylate, hydroxypropyl(meth)acrylate, polyethylene glycol mono(meth)acrylate, (meth)allyl alcohol, crotyl alcohol, isocrotyl alcohol, 1-buten-3-ol, 2-buten-1-ol, 2-butene-1,4-diol, propargyl alcohol, 2-hydroxyethyl propenyl ether, sucrose allyl ether, and the like.

(6) Nitrogen Containing Monomer Having Polymeric Double Bond

Examples of a nitrogen containing monomer having polymeric double bond may include a monomer shown in (6-1) to (6-4) below.

(6-1) Monomer Having Amino Group and Polymeric Double Bond

Examples of a monomer having an amino group and polymeric double bond may include aminoethyl(meth)acrylate, dimethylaminoethyl(meth)acrylate, diethylaminoethyl(meth)acrylate, t-butylaminoethyl methacrylate, N-aminoethyl(meth)acrylamide, (meth)allyl amine, morpholinoethyl(meth)acrylate, 4-vinylpyridine, 2-vinylpyridine, crotyl amine, N,N-dimethylamino styrene, methyl-α-acetamino acrylate, vinylimidazole, N-vinylpyrrole, N-vinyl thiopyrrolidone, N-aryl phenylenediamine, aminocarbazole, aminothiazole, aminoindole, aminopyrrole, aminoimidazole, aminomercaptothiazole, and the like.

The monomer having an amino group and polymeric double bond may be the salts of the monomer listed above. Examples of the salts of the monomer listed above may include salts listed as the “salt of the monomer above” in “(2) Monomer Having Carboxyl Group and Polymeric Double Bond and Salt Thereof” above.

(6-2) Monomer Having Amide Group and Polymeric Double Bond

Examples of a monomer having an amide group and polymeric double bond may include (meth)acrylamide, N-methyl(meth)acrylamide, N-butyl acrylamide, diacetone acrylamide, N-methylol(meth)acrylamide, N,N′-methylene-bis(meth)acrylamide, cinnamic acid amide, N,N-dimethylacrylamide, N,N-dibenzylacrylamide, methacrylformamide, N-methyl-N-vinylacetamide, N-vinylpyrrolidone, and the like.

(6-3) Monomer Having Carbon Number from 3 to 10 and Having Nitrile Group and Polymeric Double Bond

Examples of a monomer having a carbon number from 3 to 10 and having a nitrile group and polymeric double bond may include (meth)acrylonitrile, cyanostyrene, cyanoacrylate, and the like.

(6-4) Monomer Having Carbon Number from 8 to 12 and Having Nitro Group and Polymeric Double Bond

Examples of a monomer having a carbon number from 8 to 12 and having a nitro group and polymeric double bond may include nitrostyrene and the like.

(7) Monomer Having Carbon Number from 6 to 18 and Having Epoxy Group and Polymeric Double Bond

Examples of a monomer having a carbon number from 6 to 18 and having an epoxy group and polymeric double bond may include glycidyl(meth)acrylate and the like.

(8) Monomer Having Carbon Number from 2 to 16 and Having Halogen Element and Polymeric Double Bond

Examples of a monomer having a carbon number from 2 to 16 and having a halogen element and polymeric double bond may include vinyl chloride, vinyl bromide, vinylidene chloride, allyl chloride, chlorostyrene, bromostyrene, dichlorostyrene, chloromethylstyrene, tetrafluorostyrene, chloroprene, and the like.

(9) Others

Other than the monomers above, examples of a monomer having polymeric double bond may include a monomer shown in (9-1) to (9-4) below.

(9-1) Ester Having Carbon Number from 4 to 16 and Having Polymeric Double Bond

Examples of an ester having a carbon number from 4 to 16 and having polymeric double bond may include vinyl acetate, vinyl propionate, vinyl butyrate, diallyl phthalate, diallyl adipate, isopropenyl acetate, vinyl methacrylate, methyl-4-vinyl benzoate, cyclohexyl methacrylate, benzyl methacrylate, phenyl(meth)acrylate, vinyl methoxy acetate, vinyl benzoate, ethyl-α-ethoxy acrylate, alkyl(meth)acrylate having an alkyl group having a carbon number from 1 to 11 [such as methyl(meth)acrylate, ethyl(meth)acrylate, propyl(meth)acrylate, butyl(meth)acrylate, or 2-ethylhexyl(meth)acrylate], dialkyl fumarate (two alkyl groups being straight-chain alkyl groups, branched alkyl groups, or alicyclic alkyl groups, having a carbon number from 2 to 8), dialkyl maleate (two alkyl groups being straight-chain alkyl groups, branched alkyl groups, or alicyclic alkyl groups, having a carbon number from 2 to 8), poly(meth)allyloxy alkanes (such as diallyloxyethane, triallyloxyethane, tetraallyloxyethane, tetraallyloxypropane, tetraallyloxybutane, or tetramethallyloxyethane), a monomer having a polyalkylene glycol chain and polymeric double bond [such as polyethylene glycol (number average molecular weight (hereinafter, also referred to as “Mn”)=300) mono(meth)acrylate, polypropylene glycol (Mn=500) monoacrylate, a 10-mole adduct (meth)acrylate of ethylene oxide (hereinafter “ethylene oxide” being abbreviated as “EO”) to methyl alcohol or a 30-mole adduct (meth)acrylate of EO to lauryl alcohol], poly(meth)acrylates {such as poly(meth)acrylate of polyhydric alcohols [such as ethylene glycol di(meth)acrylate, propylene glycol di(meth)acrylate, neopentyl glycol di(meth)acrylate, trimethylol propane tri(meth)acrylate, or polyethylene glycol di(meth)acrylate]}, and the like. “(Meth)allylo” herein means “allylo and/or methallylo”.

(9-2) Ether Having Carbon Number from 3 to 16 and Having Polymeric Double Bond

Examples of ether having a carbon number from 3 to 16 and having polymeric double bond may include vinyl methyl ether, vinyl ethyl ether, vinyl propyl ether, vinyl butyl ether, vinyl-2-ethyl hexyl ether, vinyl phenyl ether, vinyl-2-methoxy ethyl ether, methoxy butadiene, vinyl-2-butoxyethyl ether, 3,4-dihydro-1,2-pyran, 2-butoxy-2′-vinyloxy diethyl ether, acetoxystyrene, phenoxystyrene, and the like.

(9-3) Ketone Having Carbon Number from 4 to 12 and Having Polymeric Double Bond

Examples of ketone having a carbon number from 4 to 12 and having polymeric double bond may include vinyl methyl ketone, vinyl ethyl ketone, vinyl phenyl ketone, and the like.

(9-4) Sulfur Containing Compound Having Carbon Number from 2 to 16 and Having Polymeric Double Bond Other than Polymeric Double Bond Above

Examples of a sulfur containing compound having a carbon number from 2 to 16 and having polymeric double bond may include divinyl sulfide, p-vinyl diphenyl sulfide, vinyl ethyl sulfide, vinyl ethyl sulfone, divinyl sulfone, divinylsulfoxide, and the like.

Specific examples of a vinyl resin may include a styrene-(meth)acrylic acid ester copolymer, a styrene-butadiene copolymer, a (meth)acrylic acid-(meth)acrylic acid ester copolymer, a styrene-acrylonitrile copolymer, a styrene-maleic acid (maleic anhydride) copolymer, a styrene-(meth)acrylic acid copolymer, a styrene-(meth)acrylic acid-divinylbenzene copolymer, a styrene-styrene sulfonic acid-(meth)acrylic acid ester copolymer, and the like.

The vinyl resin may be a homopolymer or a copolymer of a monomer having polymeric double bond in (1) to (9) above, or it may be a polymerized product of a monomer having polymeric double bond in (1) to (9) above and a monomer (m) having a molecular chain (k) and having polymeric double bond. Examples of the molecular chain (k) may include a straight-chain or branched hydrocarbon chain having a carbon number from 12 to 27, a fluoro-alkyl chain having a carbon number from 4 to 20, a polydimethylsiloxane chain, and the like. A difference in SP value between the molecular chain (k) in the monomer (m) and the insulating liquid (L) is preferably 2 or smaller. The “SP value” herein is a numeric value calculated with a Fedors' method [Polym. Eng. Sci. 14(2) 152, (1974)].

Examples of the monomer (m) having the molecular chain (k) and polymeric double bond may include, but are not particularly limited to, monomers (m1) to (m4) below. Two or more of the monomers (m1) to (m4) may be used together as the monomer (m).

“Monomer (m1) Having Straight-Chain Hydrocarbon Chain Having Carbon Number from 12 to 27 (Preferably from 16 to 25) and Polymeric Double Bond”

Examples of such a monomer (m1) may include mono-straight-chain alkyl (a carbon number of alkyl being from 12 to 27) ester of unsaturated monocarboxylic acid, mono-straight-chain alkyl (a carbon number of alkyl being from 12 to 27) ester of unsaturated dicarboxylic acid, and the like. Examples of unsaturated monocarboxylic acid and unsaturated dicarboxylic acid may include a carboxyl group containing vinyl monomers having a carbon number from 3 to 24 such as (meth)acrylic acid, maleic acid, fumaric acid, crotonic acid, itaconic acid, and citraconic acid, and the like.

Specific examples of the monomer (m1) may include dodecyl(meth)acrylate, stearyl(meth)acrylate, behenyl(meth)acrylate, hexadecyl(meth)acrylate, heptadecyl(meth)acrylate, eicosyl(meth)acrylate, and the like.

“Monomer (m2) Having Branched Hydrocarbon Chain Having Carbon Number from 12 to 27 (Preferably from 16 to 25) and Polymeric Double Bond”

Examples of such a monomer (m2) may include branched alkyl (a carbon number of alkyl being from 12 to 27) ester of unsaturated monocarboxylic acid, mono-branched alkyl (a carbon number of alkyl being from 12 to 27) ester of unsaturated dicarboxylic acid, and the like. Examples of unsaturated monocarboxylic acid and unsaturated dicarboxylic acid may include those as listed as specific examples of unsaturated monocarboxylic acid and unsaturated dicarboxylic acid with regard to the monomer (m1).

Specific examples of the monomer (m2) may include 2-decyltetradecyl(meth)acrylate and the like.

“Monomer (m3) Having Fluoro-Alkyl Chain Having Carbon Number from 4 to 20 and Polymeric Double Bond”

Examples of such a monomer (m3) may include perfluoroalkyl (alkyl)(meth)acrylic acid ester and the like expressed with a Chemical Formula (4) below.

CH₂═CR—COO—(CH₂)ₚ—(CF₂)_{q}—Z Chemical Formula (4)

In Chemical Formula (4) above, R represents a hydrogen atom or a methyl group, p represents an integer from 0 to 3, q represents any of 2, 4, 6, 8, 10, and 12, and Z represents a hydrogen atom or a fluorine atom.

Specific examples of the monomer (m3) may include [(2-perfluoroethyl) ethyl](meth)acrylic acid ester, [(2-perfluorobutyl)ethyl](meth)acrylic acid ester, [(2-perfluorohexyl)ethyl](meth)acrylic acid ester, [(2-perfluorooctyl)ethyl](meth)acrylic acid ester, [(2-perfluorodecyl)ethyl](meth)acrylic acid ester, [(2-perfluorododecyl)ethyl](meth)acrylic acid ester, and the like.

“Monomer (m4) Having Polydimethylsiloxane Chain and Polymeric Double Bond”

Examples of such a monomer (m4) may include (meth)acrylic modified silicone and the like expressed with a Chemical Formula (5) below.

CH₂═CR—COOR′—((CH₃)₂SiO)ₘ—Si(CH₃)₃ Chemical Formula (5)

In Chemical Formula (5) above, R represents a hydrogen atom or a methyl group, R′ represents an alkylene group having a carbon number from 1 to 20, and m is from 15 to 45 on average.

Specific examples of the monomer (m4) may include modified silicone oil (such as “X-22-174DX”, “X-22-2426”, or “X-22-2475” manufactured by Shin-Etsu Chemical Co., Ltd.) and the like.

Among the monomers (m1) to (m4), a preferred monomer is the monomer (m1) and the monomer (m2), and a more preferred monomer is the monomer (m2).

A content of the monomer (m) is preferably from 10 to 90 mass %, more preferably from 15 to 80 mass %, and further preferably from 20 to 60 mass %, with respect to a mass of the vinyl resin. So long as the content of the monomer (m) is within the range above, toner particles are less likely to unite with each other.

In a case where a monomer having polymeric double bond in (1) to (9) above, the monomer (m1), and the monomer (m2) are polymerized to make up a vinyl resin, from a point of view of form of the toner particles and the fixability of the toner particles, a mass ratio between the monomer (m1) and the monomer (m2) [(m1):(m2)] is preferably from 90:10 to 10:90, more preferably from 80:20 to 20:80, and further preferably from 70:30 to 30:70.

<Polyester Resin>

Examples of a polyester resin may include a polycondensed product and the like of polyol and polycarboxylic acid, acid anhydride of polycarboxylic acid, or lower alkyl (a carbon number of an alkyl group being from 1 to 4) ester of polycarboxylic acid. A known polycondensation catalyst or the like can be used for polycondensation reaction.

Examples of polyol may include diol (10), polyol (11) having valence not smaller than 3 to 8 (hereinafter abbreviated as “polyol (11)”), and the like.

Examples of polycarboxylic acid may include dicarboxylic acid (12), polycarboxylic acid (13) having valence not smaller than 3 to 6 (hereinafter abbreviated as “polycarboxylic acid (13)”), and the like. Examples of acid anhydride of polycarboxylic acid may include acid anhydride of dicarboxylic acid (12), acid anhydride of polycarboxylic acid (13), and the like. Examples of lower alkyl ester of polycarboxylic acid may include lower alkyl ester of dicarboxylic acid (12), lower alkyl ester of polycarboxylic acid (13), and the like.

A ratio between polyol and polycarboxylic acid is not particularly limited. A ratio between polyol and polycarboxylic acid should only be set such that an equivalent ratio between a hydroxyl group [OH] and a carboxyl group [COOH] ([OH]/[COOH]) is set preferably to 2/1 to 1/5, more preferably to 1.5/1 to 1/4, and further preferably to 1.3/1 to 1/3.

Examples of diol (10) may include alkylene glycol having a carbon number from 2 to 30 (such as ethylene glycol, 1,2-propylene glycol, 1,3-propylene glycol, 1,4-butanediol, 1,6-hexanediol, octanediol, decanediol, dodecanediol, tetradecanediol, neopentylglycol, or 2,2-diethyl-1,3-propanediol), alkylene ether glycol having Mn=106 to 10000 (such as diethylene glycol, triethylene glycol, dipropylene glycol, polyethylene glycol, polypropylene glycol, or polytetramethylene ether glycol), alicyclic diol having a carbon number from 6 to 24 (such as 1,4-cyclohexanedimethanol or hydrogenated bisphenol A), an adduct (the number of added moles being from 2 to 100) of alkylene oxide (hereinafter “alkylene oxide” being abbreviated as “AO”) to alicyclic diol above having Mn=100 to 10000 (such as a 10-mole adduct of EO to 1,4-cyclohexanedimethanol), an adduct (the number of added moles being from 2 to 100) of AO [such as EO, propylene oxide (hereinafter abbreviated as “PO”), or butylene oxide] to bisphenols having a carbon number from 15 to 30 (such as bisphenol A, bisphenol F, or bisphenol S), an adduct of AO above to polyphenol having a carbon number from 12 to 24 (such as catechol, hydroquinone, or resorcin) (such as a 2 to 4-mole adduct of EO to bisphenol A or a 2 to 4-mole adduct of PO to bisphenol A), polylactonediol having a weight average molecular weight (hereinafter abbreviated as “Mw”)=100 to 5000 (such as poly-ε-caprolactonediol), polybutadienediol having Mw=1000 to 20000, and the like.

Among these, as diols (10), alkylene glycol and an adduct of AO to bisphenols are preferred and an adduct alone of AO to bisphenols and a mixture of an adduct of AO to bisphenols and alkylene glycol are more preferred.

Examples of polyol (11) may include aliphatic polyhydric alcohol having valence not smaller than 3 to 8 and having a carbon number from 3 to 10 (such as glycerol, trimethylolethane, trimethylolpropane, pentaerythritol, sorbitan, or sorbitol), an adduct (the number of added moles being from 2 to 100) of AO (having a carbon number from 2 to 4) to trisphenol having a carbon number from 25 to 50 (such as a 2 to 4-mole adduct of EO to trisphenol or a 2 to 4-mole adduct of PO to trisphenol polyamide), an adduct (the number of added moles being from 2 to 100) of AO (having a carbon number from 2 to 4) to a novolac resin (such as phenol novolac or cresol novolac) having n=3 to 50 (such as a 2-mole adduct of PO to phenol novolac or a 4-mole adduct of EO to phenol novolac), an adduct (the number of added moles being from 2 to 100) of AO (having a carbon number from 2 to 4) to polyphenol having a carbon number from 6 to 30 (such as pyrogallol, phloroglucinol, or 1,2,4-benzenetriol) (such as a 4-mole adduct of EO to pyrogallol), acrylic polyol having n=20 to 2000 {such as a copolymer of hydroxyethyl(meth)acrylate and a monomer having other polymeric double bond [such as styrene, (meth)acrylic acid, or (meth)acrylic acid ester]}, and the like.

Among these, as polyol (11), aliphatic polyhydric alcohol and an adduct of AO to a novolac resin is preferred, and an adduct of AO to a novolac resin is more preferred.

Examples of dicarboxylic acid (12) may include alkane dicarboxylic acid having a carbon number from 4 to 32 (such as succinic acid, adipic acid, sebacic acid, azelaic acid, dodecane dicarboxylic acid, or octadecane dicarboxylic acid), alkene dicarboxylic acid having a carbon number from 4 to 32 (such as maleic acid, fumaric acid, citraconic acid, or mesaconic acid), branched alkene dicarboxylic acid having a carbon number from 8 to 40 [such as dimer acid or alkenyl succinic acid (such as dodecenyl succinic acid, pentadecenyl succinic acid, or octadecenyl succinic acid)], branched alkane dicarboxylic acid having a carbon number from 12 to 40 [such as alkyl succinic acid (such as decyl succinic acid, dodecyl succinic acid, or octadecyl succinic acid)], aromatic dicarboxylic acid having a carbon number from 8 to 20 (such as phthalic acid, isophthalic acid, terephthalic acid, or naphthalene dicarboxylic acid), and the like.

Among these, as dicarboxylic acid (12), alkene dicarboxylic acid and aromatic dicarboxylic acid are preferred, and aromatic dicarboxylic acid is more preferred.

Examples of polycarboxylic acid (13) may include aromatic polycarboxylic acid having a carbon number from 9 to 20 (such as trimellitic acid or pyromellitic acid) and the like.

Examples of the acid anhydride of dicarboxylic acid (12) and polycarboxylic acid (13) may include trimellitic anhydride, pyromellitic anhydride, and the like. Examples of the lower alkyl ester of dicarboxylic acid (12) and polycarboxylic acid (13) may include methyl ester, ethyl ester, isopropyl ester, and the like.

<Polyurethane Resin>

A polyurethane resin may be, for example, a polyadduct of polyisocyanate (14) and an active hydrogen containing compound {for example, water, polyol [such as diol (10) (including diol having a functional group other than a hydroxyl group) or polyol (11)], polycarboxylic acid [such as dicarboxylic acid (12) or polycarboxylic acid (13)], polyester polyol obtained by polycondensation between polyol and polycarboxylic acid, a ring-opening polymer of lactone having a carbon number from 6 to 12, polyamine (15), polythiol (16), and use of two or more types of these}. A polyurethane resin may be, for example, an amino group containing polyurethane resin or the like, obtained by causing a terminal isocyanate group prepolymer resulting from reaction between polyisocyanate (14) and the active hydrogen containing compound above to react with primary and/or secondary monoamine(s) (17) in parts equal to an isocyanate group of the terminal isocyanate group prepolymer.

A content of a carboxyl group in the polyurethane resin is preferably from 0.1 to 10 mass %.

Examples of polyisocyanate (14) may include: aromatic polyisocyanate having a carbon number from 6 to 20 (except for carbon in an NCO group; hereinafter to be similarly understood in <Polyurethane Resin>), aliphatic polyisocyanate having a carbon number from 2 to 18, a modified product of these polyisocyanates (such as a modified product including a urethane group, a carbodiimide group, an allophanate group, a urea group, a biuret group, a uretdione group, a uretonimine group, an isocyanurate group, an oxazolidone group, or the like), use of two or more types of these, and the like.

Examples of aromatic polyisocyanate may include 1,3- or 1,4-phenylene diisocyanate, 2,4- or 2,6-tolylene diisocyanate (hereinafter abbreviated as “TDI”), crude TDI, m- or p-xylylene diisocyanate, α,α,α′,α′-tetramethylxylylene diisocyanate, 2,4′- or 4,4′-diphenylmethane diisocyanate (hereinafter abbreviated as “MDI”), crude MDI {such as a phosgenated product of crude diaminophenylmethane [such as a condensed product of formaldehyde and aromatic amine (one type may be used or two or more types may be used together) or a mixture of diaminodiphenylmethane and a small amount (for example, 5 to 20 mass %) of polyamine having three or more amine groups] or polyallyl polyisocyanate}, 1,5-naphtylene diisocyanate, 4,4′,4″-triphenylmethane triisocyanate, m- or p-isocyanatophenylsulfonyl isocyanate, use of two or more types of these, and the like.

Examples of aliphatic polyisocyanate may include chain aliphatic polyisocyanate, cyclic aliphatic polyisocyanate, and the like.

Examples of chain aliphatic polyisocyanate may include ethylene diisocyanate, tetramethylene diisocyanate, hexamethylene diisocyanate (hereinafter abbreviated as “HDI”), dodecamethylene diisocyanate, 1,6,11-undecane triisocyanate, 2,2,4-trimethyl hexamethylene diisocyanate, lysine diisocyanate, 2,6-diisocyanatomethyl caproate, bis(2-isocyanatoethyl) fumarate, bis(2-isocyanatoethyl) carbonate, 2-isocyanatoethyl-2,6-diisocyanatohexanoate, use of two or more types of these, and the like.

Examples of cyclic aliphatic polyisocyanate may include isophoron diisocyanate (hereinafter abbreviated as “IPDI”), dicyclohexylmethane-4,4′-diisocyanate (hydrogenated MDI), cyclohexylene diisocyanate, methylcyclohexylene diisocyanate (hydrogenated TDI), bis(2-isocyanatoethyl)-4-cyclohexene-1,2-dicarboxylate, 2,5- or 2,6-norbornane diisocyanate, use of two or more types of these, and the like.

Examples of a modified product of polyisocyanate may include a polyisocyanate compound including at least one of a urethane group, a carbodiimide group, an allophanate group, a urea group, a biuret group, a uretdione group, a uretonimine group, an isocyanurate group, and an oxazolidone group, and the like. Examples of the modified product of polyisocyanate may include modified MDI (such as urethane-modified MDI, carbodiimide-modified MDI, or trihydrocarbyl-phosphate-modified MDI), urethane-modified TDI, use of two or more types of these [such as use of modified MDI and urethane-modified TDI (such as an isocyanate containing prepolymer) as combined], and the like.

Among these, as polyisocyanate (14), aromatic polyisocyanate having a carbon number from 6 to 15 and aliphatic polyisocyanate having a carbon number from 4 to 15 are preferred. TDI, MDI, HDI, hydrogenated MDI, and IPDI are more preferred.

Examples of polyamine (15) may include aliphatic polyamine having a carbon number from 2 to 18, aromatic polyamine (having a carbon number, for example, from 6 to 20), and the like.

Examples of aliphatic polyamine having a carbon number from 2 to 18 may include chain aliphatic polyamine, an alkyl (having a carbon number from 1 to 4) substitute of chain aliphatic polyamine, a hydroxyalkyl (having a carbon number from 2 to 4) substitute of chain aliphatic polyamine, cyclic aliphatic polyamine, and the like.

Examples of chain aliphatic polyamine may include alkylene diamine having a carbon number from 2 to 12 (such as ethylene diamine, propylene diamine, trimethylene diamine, tetramethylene diamine, or hexamethylene diamine), polyalkylene (having a carbon number from 2 to 6) polyamine [such as diethylene triamine, iminobispropylamine, bis(hexamethylene)triamine, triethylenetetramine, tetraethylenepentamine, or pentaethylenehexamine], and the like.

Examples of the alkyl (having a carbon number from 1 to 4) substitute of chain aliphatic polyamine and the hydroxyalkyl (having a carbon number from 2 to 4) substitute of chain aliphatic polyamine may include dialkyl (having a carbon number from 1 to 3) aminopropyl amine, trimethyl hexamethylene diamine, aminoethyl ethanol amine, 2,5-dimethyl-2,5-hexamethylene diamine, methyliminobispropylamine, and the like.

Examples of cyclic aliphatic polyamine may include alicyclic polyamine having a carbon number from 4 to 15 [such as 1,3-diaminocyclohexane, isophoron diamine, menthene diamine, 4,4′-methylene dicyclohexane diamine (hydrogenated methylenedianiline), or 3,9-bis(3-aminopropyl)-2,4,8,10-tetraoxaspiro[5,5]undecane], heterocyclic polyamine having a carbon number from 4 to 15 [such as piperazine, N-aminoethylpiperazine, 1,4-diaminoethylpiperazine, or 1,4-bis(2-amino-2-methylpropyl) piperazine], and the like.

Examples of aromatic polyamine (having a carbon number from 6 to 20) may include non-substituted aromatic polyamine, aromatic polyamine having an alkyl group (for example, an alkyl group having a carbon number from 1 to 4, such as a methyl group, an ethyl group, an n-propyl group, an isopropyl group, and a butyl group), aromatic polyamine having an electron-withdrawing group (such as halogen atoms such as Cl, Br, I, and F, alkoxy groups such as a methoxy group and an ethoxy group, as well as a nitro group), aromatic polyamine having a secondary amino group, and the like.

Examples of non-substituted aromatic polyamine may include 1,2-, 1,3-, or 1,4-phenylene diamine, 2,4′- or 4,4′-diphenyl methane diamine, crude diphenyl methane diamine (such as polyphenyl polymethylene polyamine), diaminodiphenyl sulfone, benzidine, thiodianiline, bis(3,4-diaminophenyl) sulfone, 2,6-diaminopyridine, m-aminobenzyl amine, triphenylmethane-4,4′,4″-triamine, naphtylene diamine, use of two or more types of these, and the like.

Examples of aromatic polyamine having an alkyl group (for example, an alkyl groups having a carbon number from 1 to 4, such as a methyl group, an ethyl group, an n-propyl group, an isopropyl group, and a butyl group) may include 2,4- or 2,6-tolylene diamine, crude tolylene diamine, diethyl tolylene diamine, 4,4′-diamino-3,3′-dimethyldiphenylmethane, 4,4′-bis(o-toluidine), dianisidine, diaminoditolyl sulfone, 1,3-dimethyl-2,4-diaminobenzene, 1,3-diethyl-2,4-diaminobenzene, 1,3-dimethyl-2,6-diaminobenzene, 1,4-diethyl-2,5-diamino benzene, 1,4-diisopropyl-2,5-diaminobenzene, 1,4-dibutyl-2,5-diaminobenzene, 2,4-diaminomesitylene, 1,3,5-triethyl-2,4-diaminobenzene, 1,3,5-triisopropyl-2,4-diaminobenzene, 1-methyl-3,5-diethyl-2,4-diaminobenzene, 1-methyl-3,5-diethyl-2,6-diaminobenzene, 2,3-dimethyl-1,4-diaminonaphthalene, 2,6-dimethyl-1,5-diaminonaphthalene, 2,6-diisopropyl-1,5-diaminonaphthalene, 2,6-dibutyl-1,5-diaminonaphthalene, 3,3′,5,5′-tetramethylbenzidine, 3,3′,5,5′-tetraisopropylbenzidine, 3,3′,5,5′-tetramethyl-4,4′-diaminodiphenylmethane, 3,3′,5,5′-tetraethyl-4,4′-diaminodiphenylmethane, 3,3′,5,5′-tetraisopropyl-4,4′-diaminodiphenylmethane, 3,3′,5,5′-tetrabutyl-4,4′-diaminodiphenylmethane, 3,5-diethyl-3′-methyl-2′,4-diaminodiphenylmethane, 3,5-diisopropyl-3′-methyl-2′,4-diaminodiphenylmethane, 3,3′-diethyl-2,2′-diaminodiphenylmethane, 4,4′-diamino-3,3′-dimethyldiphenylmethane, 3,3′,5,5′-tetraethyl-4,4′-diaminobenzophenone, 3,3′,5,5′-tetraisopropyl-4,4′-diaminobenzophenone, 3,3′,5,5′-tetraethyl-4,4′-diaminodiphenyl ether, 3,3′,5,5′-tetraisopropyl-4,4′-diaminodiphenyl sulfone, use of two or more types of these, and the like.

Examples of aromatic polyamine having an electron-withdrawing group (such as halogen atoms such as Cl, Br, I, and F, alkoxy groups such as a methoxy group and an ethoxy group, as well as a nitro group) may include: methylenebis-o-chloroaniline, 4-chloro-o-phenylenediamine, 2-chloro-1,4-phenylenediamine, 3-amino-4-chloroaniline, 4-bromo-1,3-phenylenediamine, 2,5-dichloro-1,4-phenylenediamine, 5-nitro-1,3-phenylenediamine, 3-dimethoxy-4-aminoaniline, 4,4′-diamino-3,3′-dimethyl-5,5′-dibromo-diphenylmethane, 3,3′-dichlorobenzidine, 3,3′-dimethoxybenzidine, bis(4-amino-3-chlorophenyl) oxide, bis(4-amino-2-chlorophenyl) propane, bis(4-amino-2-chlorophenyl) sulfone, bis(4-amino-3-methoxy phenyl) decane, bis(4-aminophenyl) sulfide, bis(4-aminophenyl) telluride, bis(4-aminophenyl) selenide, bis(4-amino-3-methoxyphenyl)disulfide, 4,4′-methylenebis(2-iodoaniline), 4,4′-methylenebis(2-bromoaniline), 4,4′-methylenebis(2-fluoroaniline), 4-aminophenyl-2-chloroaniline, and the like.

Examples of aromatic polyamine having a secondary amino group may include polyamine in which a part or entirety of —NH₂ in non-substituted aromatic polyamine above, aromatic polyamine having an alkyl group, and aromatic polyamine having an electron-withdrawing group has been substituted with —NH—R′ (R′ representing an alkyl group, and for example, representing lower alkyl groups such as a methyl group and an ethyl group having a carbon number from 1 to 4) [such as 4,4′-di(methylamino)diphenylmethane or 1-methyl-2-methylamino-4-aminobenzene], polyamide polyamine, low-molecular-weight polyamide polyamine obtained by condensation of dicarboxylic acid (such as a dimer acid) and an excess (at least 2 moles per 1 mole of acid) of polyamines (such as alkylenediamine above or polyalkylenepolyamine), polyether polyamine, a hydride of a cyanoethylated product of polyether polyol (such as polyalkylene glycol), and the like.

Examples of polythiol (16) may include alkane dithiols having a carbon number from 2 to 36 (such as ethanedithiol, 1,4-butanedithiol, and 1,6-hexanedithiol), and the like.

Examples of primary and/or secondary monoamine(s) (17) may include alkylamine having a carbon number from 2 to 24 (such as ethylamine, n-butyl amine, isobutylamine, diethylamine, or n-butyl-n-dodecyl amine), and the like.

<Epoxy Resin>

Examples of an epoxy resin may include a ring-opening polymerized product of polyepoxide (18), a polyadduct of polyepoxide (18) and an active hydrogen containing compound [such as water, diol (10), dicarboxylic acid (12), polyamine (15), or polythiol (16)], a cured product of polyepoxide (18) and acid anhydride of dicarboxylic acid (12), and the like.

Polyepoxide (18) is not particularly limited so long as it has two or more epoxy groups in a molecule. From a point of view of mechanical characteristics of a cured product, a substance having 2 epoxy groups in a molecule is preferred as polyepoxide (18). An epoxy equivalent (a molecular weight per one epoxy group) of polyepoxide (18) is preferably from 65 to 1000 and more preferably from 90 to 500. When an epoxy equivalent is 1000 or smaller, a cross-linked structure becomes dense so that such physical properties as water resistance, chemical resistance, and mechanical strength of the cured product improve. On the other hand, when an epoxy equivalent is smaller than 65, synthesis of polyepoxide (18) may become difficult.

Examples of polyepoxide (18) may include an aromatic polyepoxy compound, an aliphatic polyepoxy compound, and the like.

Examples of an aromatic polyepoxy compound may include glycidyl ether of polyhydric phenol, glycidyl ester of aromatic polyvalent carboxylic acid, glycidyl aromatic polyamine, a glycidylated product of aminophenol, and the like.

Examples of the glycidyl ether of polyhydric phenol may include bisphenol F diglycidyl ether, bisphenol A diglycidyl ether, bisphenol B diglycidyl ether, bisphenol AD diglycidyl ether, bisphenol S diglycidyl ether, halogenated bisphenol A diglycidyl, tetrachloro bisphenol A diglycidyl ether, catechin diglycidyl ether, resorcinol diglycidyl ether, hydroquinone diglycidyl ether, pyrogallol triglycidyl ether, 1,5-dihydroxynaphthaline diglycidyl ether, dihydroxybiphenyl diglycidyl ether, octachloro-4,4′-dihydroxybiphenyl diglycidyl ether, tetramethylbiphenyl diglycidyl ether, dihydroxynaphthyl cresol triglycidyl ether, tris(hydroxyphenyl) methane triglycidyl ether, dinaphthyl triol triglycidyl ether, tetrakis(4-hydroxyphenyl)ethane tetraglycidyl ether, p-glycidyl phenyl dimethyl tolyl bisphenol A glycidyl ether, trismethyl-t-butyl-butylhydroxy methane triglycidyl ether, 9,9′-bis(4-hydroxyphenyl) fluorene diglycidyl ether, 4,4′-oxybis(1,4-phenylethyl)tetracresol glycidyl ether, 4,4′-oxybis(1,4-phenylethyl) phenyl glycidyl ether, bis(dihydroxynaphthalene)tetra glycidyl ether, glycidyl ether of phenol, glycidyl ether of a cresol novolac resin, glycidyl ether of a limonene phenol novolac resin, diglycidyl ether obtained from reaction between 2 moles of bisphenol A and 3 moles of epichlorohydrin, polyglycidyl ether of polyphenol obtained from condensation reaction between phenol and glyoxal, glutaraldehyde, or formaldehyde, polyglycidyl ether of polyphenol obtained from condensation reaction between resorcin and acetone, and the like.

Examples of the glycidyl ester of aromatic polyvalent carboxylic acid may include phthalic acid diglycidyl ester, isophthalic acid diglycidyl ester, terephthalic acid diglycidyl ester, and the like.

Examples of glycidyl aromatic polyamine may include N,N-diglycidyl aniline, N,N,N′,N′-tetraglycidyl xylylene diamine, N,N,N′,N′-tetraglycidyl diphenylmethane diamine, and the like.

Other than the compounds listed above, examples of an aromatic polyepoxy compound may include triglycidyl ether of p-aminophenol (an example of a glycidylated product of aminophenol), a diglycidyl urethane compound obtained from reaction between tolylene diisocyanate or diphenylmethane diisocyanate and glycidol, a glycidyl group containing polyurethane (pre)polymer obtained from reaction between tolylene diisocyanate or diphenylmethane diisocyanate, glycidol, and polyol, diglycidyl ether of an adduct of AO to bisphenol A, and the like.

Examples of an aliphatic polyepoxy compound may include a chain aliphatic polyepoxy compound, a cyclic aliphatic polyepoxy compound, and the like. The aliphatic polyepoxy compound may be a copolymer of diglycidyl ether and glycidyl(meth)acrylate.

Examples of a chain aliphatic polyepoxy compound may include polyglycidyl ether of polyhydric aliphatic alcohol, polyglycidyl ester of polyvalent fatty acid, glycidyl aliphatic amine, and the like.

Examples of the polyglycidyl ether of polyhydric aliphatic alcohol may include ethylene glycol diglycidyl ether, propylene glycol diglycidyl ether, tetramethylene glycol diglycidyl ether, 1,6-hexanediol diglycidyl ether, polyethylene glycol diglycidyl ether, polypropylene glycol diglycidyl ether, polytetramethylene glycol diglycidyl ether, neopentyl glycol diglycidyl ether, trimethylolpropane polyglycidyl ether, glycerol polyglycidyl ether, pentaerythritol polyglycidyl ether, sorbitol polyglycidyl ether, polyglycerol polyglycidyl ether, and the like.

Examples of the polyglycidyl ester of polyvalent fatty acid may include diglycidyl oxalate, diglycidyl maleate, diglycidyl succinate, diglycidyl glutarate, diglycidyl adipate, diglycidyl pimelate, and the like.

Examples of glycidyl aliphatic amine may include N,N,N′,N′-tetraglycidylhexamethylene diamine and the like.

Examples of a cyclic aliphatic polyepoxy compound may include trisglycidyl melamine, vinyl cyclohexene dioxide, limonene dioxide, dicyclopentadiene dioxide, bis(2,3-epoxy cyclopentyl)ether, ethylene glycol bisepoxy dicyclopentyl ether, 3,4-epoxy-6-methylcyclohexylmethyl-3′,4′-epoxy-6′-methylcyclohexane carboxylate, bis(3,4-epoxy-6-methylcyclohexylmethyl) adipate, bis(3,4-epoxy-6-methylcyclohexylmethyl) butylamine, dimer acid diglycidyl ester, and the like. Examples of a cyclic aliphatic polyepoxy compound may also include a hydrogenated product of the aromatic polyepoxy compound above.

<Polyamide Resin>

Examples of a polyamide resin may include a ring-opening polymer of lactam, a polycondensed product of aminocarboxylic acid, a polycondensed product of polycarboxylic acid and polyamine, and the like.

<Polyimide Resin>

Examples of a polyimide resin may include an aliphatic polyimide resin (such as a condensed polymer obtained from aliphatic carboxylic dianhydride and aliphatic diamine), an aromatic polyimide resin (such as a condensed polymer obtained from aromatic carboxylic dianhydride and aliphatic diamine or aromatic diamine), and the like.

<Silicon Resin>

Examples of a silicon resin may include a compound having in a molecular chain, at least one of silicon-silicon bond, silicon-carbon bond, siloxane bond, and silicon-nitrogen bond (such as polysiloxane, polycarbosilane, or polysilazane) and the like.

<Phenol Resin>

Examples of a phenol resin may include a condensed polymer obtained from phenols (such as phenol, cresol, nonyl phenol, lignin, resorcin, or catechol) and aldehydes (such as formaldehyde, acetaldehyde, or furfural), and the like.

<Melamine Resin>

Examples of a melamine resin may include a condensed product obtained from melamine and formaldehyde, and the like.

<Urea Resin>

Examples of a urea resin may include a polycondensed product obtained from urea and formaldehyde, and the like.

<Aniline Resin>

Examples of an aniline resin may include a product obtained from reaction between aniline and aldehydes in an acidic condition, and the like.

<Ionomer Resin>

Examples of an ionomer resin may include a copolymer of a monomer having polymeric double bond (such as an α-olefin based monomer or a styrene based monomer) and α,β-unsaturated carboxylic acid (such as acrylic acid, methacrylic acid, maleic acid, itaconic acid, maleic acid monomethyl ester, maleic anhydride, or maleic acid monoethyl ester), in which a part or entirety of carboxylic acid is carboxylate (such as potassium salt, sodium salt, magnesium salt, or calcium salt), and the like.

<Polycarbonate Resin>

Examples of a polycarbonate resin may include a condensed polymer of bisphenols (such as bisphenol A, bisphenol F, or bisphenol S) and phosgene, diester carbonate, and the like, and the like.

<Crystallinity•Non-Crystallinity>

The shell resin (a) may be a crystalline resin (a1), a non-crystalline resin (a2), or combination of the crystalline resin (a1) and the non-crystalline resin (a2). From a point of view of fixability of toner particles, the shell resin (a) is preferably the crystalline resin (a1).

“Crystallinity” herein means that a ratio between a softening point of a resin (hereinafter abbreviated as “Tm”) and a maximum peak temperature (hereinafter abbreviated as “Ta”) of heat of fusion of the resin (Tm/Ta) is not lower than 0.8 and not higher than 1.55 and that a result obtained in differential scanning calorimetry (DSC) does not show stepwise change in amount of heat absorption but has a clear heat absorption peak. “Non-crystallinity” herein means that a ratio between Tm and Ta (Tm/Ta) is higher than 1.55. Tm and Ta can be measured with a method below.

A flow tester (capillary rheometer) (such as “CFT-500D” manufactured by Shimadzu Corporation) can be used to measure Tm. Specifically, while 1 g of a measurement sample is heated at a temperature increase rate of 6° C./min., a plunger applies load of 1.96 MPa to the measurement sample to thereby extrude the measurement sample from a nozzle having a diameter of 1 mm and a length of 1 mm. Relation between “an amount of lowering of the plunger (a value of flow)” and a “temperature” is plotted in a graph. A temperature at the time when an amount of lowering of the plunger is ½ of a maximum value of the amount of lowering is read from the graph, and this value (a temperature at which half of the measurement sample was extruded from the nozzle) is adopted as Tm.

A differential scanning calorimeter (such as “DSC210” manufactured by Seiko Instruments, Inc.) can be used to measure Ta. Specifically, a sample to be used for measurement of Ta is initially subjected to pre-treatment. After the sample is molten at 130° C., a temperature is lowered from 130° C. to 70° C. at a rate of 1.0° C./min., and thereafter a temperature is lowered from 70° C. to 10° C. at a rate of 0.5° C./min. Then, with the DSC method, a temperature of the sample is raised at a temperature increase rate of 20° C./min., change in heat absorption and generation of the sample is measured, and relation between an “amount of heat absorption and generation” and a “temperature” is plotted in a graph. Here, a temperature of a heat absorption peak observed in a range from 20 to 100° C. is defined as Ta′. When there are a plurality of heat absorption peaks, a temperature of a peak largest in amount of heat absorption is defined as Ta′. After the sample was stored for 6 hours at (Ta′−10)° C., it is in turn stored for 6 hours at (Ta′−15)° C.

Then, with the DSC method, the sample subjected to the pre-treatment above is cooled to 0° C. at a temperature lowering rate of 10° C./min., a temperature is raised at a temperature increase rate of 20° C./min., change in heat absorption and generation is measured, and relation between an “amount of heat absorption and generation” and a “temperature” is plotted in a graph. A temperature at which an amount of heat absorption attains to a maximum value is defined as a maximum peak temperature (Ta) of heat of fusion.

<Melting Point>

The shell resin (a) has a melting point preferably from 0 to 220° C., more preferably from 30 to 200° C., and further preferably from 40 to 80° C. From a point of view of form of the toner particles, as well as powder fluidity of the liquid developer (X), heat-resistant storage stability of the liquid developer (X), resistance to stress of the liquid developer (X), and the like, the shell resin (a) has a melting point preferably not lower than a temperature at the time of manufacturing of the liquid developer (X). If a melting point of the shell resin is lower than a temperature at the time of manufacturing of the liquid developer, it may be difficult to prevent toner particles from uniting with each other and to prevent the toner particles from breaking. In addition, a width of distribution in particle size distribution of the toner particles may be difficult to be small. In other words, variation in particle size of toner particles may be great.

A melting point is herein measured with the use of a differential scanning calorimetry apparatus (such as “DSC20” or “SSC/580” manufactured by Seiko Instruments, Inc.) in compliance with a method defined under ASTM D3418-82.

<Mn (Number Average Molecular Weight) and Mw (Weight Average Molecular Weight)>

Mn [obtained from measurement with gel permeation chromatography (hereinafter abbreviated as “GPC”)] of the shell resin (a) is preferably from 100 to 5000000, preferably from 200 to 5000000, and further preferably from 500 to 500000.

Mn and Mw of a resin (except for a polyurethane resin) herein are measured under conditions below, with the use of GPC, with regard to a soluble content of tetrahydrofuran (hereinafter abbreviated as “THF”).

Measurement Apparatus: “HLC-8120” manufactured by Tosoh Corporation

Column: “TSKgel GMHXL” (two) manufactured by Tosoh Corporation and “TSKgel Multipore HXL-M” (one) manufactured by Tosoh Corporation

Sample Solution: 0.25 mass % of THF solution

Amount of Injection of Sample Solution into Column: 100 μA

Flow Rate: 1 ml/min.

Measurement Temperature: 40° C.

Detection Apparatus Refraction index detector

Reference Material: 12 standard polystyrenes manufactured by Tosoh Corporation (TSK standard POLYSTYRENE) (molecular weight: 500, 1050, 2800, 5970, 9100, 18100, 37900, 96400, 190000, 355000, 1090000, 2890000)

In a case where a polyurethane resin is adopted as the shell resin (a), Mn and Mw are measured under conditions below, with the use of GPC.

Measurement Apparatus: “HLC-8220GPC” manufactured by Tosoh Corporation

Column: “Guardcolumn α” (one) and “TSKgel α-M” (one) manufactured by Tosoh Corporation

Sample Solution: 0.125 mass % of dimethylformamide solution

Amount of Injection of Sample Solution into Column: 100 μl

Flow Rate: 1 ml/min.

Measurement Temperature: 40° C.

Detection Apparatus Refraction index detector

Reference Material: 12 standard polystyrenes manufactured by Tosoh Corporation (TSK standard POLYSTYRENE) (molecular weight: 500, 1050, 2800, 5970, 9100, 18100, 37900, 96400, 190000, 355000, 1090000, 2890000)

<SP Value>

The shell resin (a) has an SP value preferably from 7 to 18 (cal/cm³)^{1/2} and more preferably from 8 to 14 (cal/cm³)^{1/2}.

<Shell Particle (A)>

The shell particle (A) of the present embodiment contains a shell resin (a). A method of manufacturing the shell particle (A) may be any known methods and is not particularly limited. Examples of the method may include [1] to [7] below.

[1]: The shell resin (a) is crushed with a dry method with the use of a known dry type crusher such as a jet mill.

[2]: Powders of the shell resin (a) are dispersed in an organic solvent, and the resultant product is crushed with a wet method with the use of a known wet type disperser such as a bead mill or a roll mill.

[3]: A solution of the shell resin (a) is sprayed and dried with the use of a spray dryer or the like.

[4]: A poor solvent is added to a solution of the shell resin (a) or the solution is cooled, to thereby supersaturate and precipitate the shell resin (a).

[5]: A solution of the shell resin (a) is dispersed in water or an organic solvent.

[6]: A precursor of the shell resin (a) is polymerized in water with an emulsion polymerization method, a soap-free emulsion polymerization method, a seed polymerization method, a suspension polymerization method, or the like.

[7]: A precursor of the shell resin (a) is polymerized in an organic solvent through dispersion polymerization or the like.

Among the methods, from a point of view of ease in manufacturing of the shell particle (A), the methods [4], [6] and [7] are preferable, and the methods [6] and [7] are more preferable.

<Core Resin (b) and Core Particle (B)>

The core particle (B) of the present embodiment contains the core resin (b).

The core resin (b) may be any resin so long as it is publicly known. Specific examples of the core resin (b) may include similar resins to those listed as the specific examples of the shell resin (a). Among the specific examples of the shell resin (a), the polyester resin, the polyurethane resin, the epoxy resin, the vinyl resin, and the combined use thereof are preferably used as the core resin (b).

Moreover, it has been found that when the core resin (b) is made to have a crystalline structure, the form of the toner particles is obtained with ease. The crystallinity appears by appropriately selecting constituent components of the core resin (b). From a point of view of improvement in crystallinity, preferably, the core resin (b) contains, as a constituent component, a monomer having a carbon number of not smaller than 4 and having a straight chain alkyl skeleton. Preferable examples of the monomer that forms the core resin (b) may include aliphatic dicarboxylic acid, aliphatic diol, and the like.

What is preferred as aliphatic dicarboxylic acid is alkane dicarboxylic acid having a carbon number from 4 to 20, alkene dicarboxylic acid having a carbon number of 4 to 36, an ester forming derivative thereof, or the like. What is more preferred as aliphatic dicarboxylic acid is succinic acid, adipic acid, sebacic acid, maleic acid, fumaric acid, or the like, or an ester forming derivative thereof.

What is preferred as aliphatic diol is ethylene glycol, 1,3-propylene glycol, 1,4-butanediol, 1,6-hexanediol, 1,9-nonanediol, or 1,10-decanediol.

<Mn, Melting Point, Glass Transition Temperature (Hereinafter, Abbreviated as “Tg”) and SP Value>

Each of Mn, a melting point, Tg, and an SP value of the core resin (b) may be adjusted as appropriate within a preferable range.

For example, Mn, a melting point, Tg, and an SP value of the core resin (b) preferably have values shown below. The core resin (b) has Mn preferably from 1000 to 5000000 and more preferably from 2000 to 5000000. The core resin (b) has a melting point preferably from 20 to 300° C. and more preferably from 80 to 250° C. The core resin (b) has Tg preferably from 20 to 200° C. and more preferably from 40 to 150° C. The core resin (b) has an SP value preferably from 8 to 16 (cal/cm³)^{1/2} and more preferably from 9 to 14 (cal/cm³)^{1/2}.

Herein, Tg may be measured with a differential scanning calorimetry (DSC) method or with a flow tester. In a case where Tg is measured with the DSC method, for example, a differential scanning calorimetry apparatus (“DSC20”, “SSC/580”, or the like manufactured by Seiko Instruments, Inc.) is preferably used to measure Tg in compliance with a method defined under ASTM D3418-82.

In a case where Tg is measured with a flow tester, a flow tester (capillary rheometer) (such as “CFT-500 D type” manufactured by Shimadzu Corporation) is preferably employed. One example of measurement conditions of Tg in this case is shown below.

Load: 30 kg/cm²

Rate of Temperature Increase: 3.0° C./min.

Die Diameter: 0.50 mm

Die Length: 10.0 mm

<Core-Shell Structure>

The resin contained in the toner particles of the present embodiment preferably has a core-shell structure that the shell particles (A) containing the shell resin (a) are attached to or cover surfaces of the core particles (B) containing the core resin (b) as described above.

In this case, the volume-based median size of the shell particles (A) may be appropriately adjusted to obtain the particle size suitable for obtaining toner particles (C) having the desired particle size. The median size of the shell particle (A) is preferably 0.0005 to 3 μm. An upper limit value of the median size of the shell particles (A) is more preferably 2 μm, further preferably 1 μm. A lower limit of the median size of the shell particle (A) is more preferably 0.01 μm, further preferably 0.02 μm, most preferably 0.04 μm. In the case of obtaining toner particles (C) having the median size of 1 μm, the median size of the shell particle (A) is preferably 0.0005 to 0.3 μm, more preferably 0.001 to 0.2 μm. In the case of obtaining toner particle (C) having the median size of 10 μm, the median size of the shell particle (A) is preferably 0.005 to 3 μm, more preferably 0.05 to 2 μm.

A mass ratio between the shell particles (A) and the core particles (B) [(A):(B)] is preferably from 1:99 to 70:30. From a point of view of uniformity in a particle size of toner particles (C), heat-resistant stability of the liquid developer (X), and the like, the ratio [(A):(B)] above is more preferably from 2:98 to 50:50 and further preferably from 3:97 to 35:65. When a content (a mass ratio) of the shell particles (A) is too low, blocking resistance of the toner particles may lower. When a content (a mass ratio) of the core particles is too high, uniformity in particle size of the toner particles may lower.

From a point of view of particle size distribution of the toner particles (C) and heat-resistant stability of the liquid developer (X), the core-shell structure of the toner particles (C) is preferably composed of 1 to 70 mass % (more preferably 5 to 50 mass % and further preferably 10 to 35 mass %) of the film-shaped shell particles (A) and 30 to 99 mass % (more preferably 50 to 95 mass % and further preferably 65 to 90 mass %) of the core particles (B), with respect to a mass of the toner particles (C).

From a point of view of fixability of the toner particles (C) and heat-resistant stability of the liquid developer (X), a content of the toner particles (C) in the liquid developer (X) is preferably from 10 to 50 mass %, more preferably from 15 to 45 mass %, and further preferably from 20 to 40 mass %.

<Additive, and the Like>

The toner particles (C) of the present embodiment preferably contain a coloring agent in at least one of the shell particles (A) and the core particles (B), and they may further contain an additive other than the coloring agent (such as a dispersant for pigment, a wax, a charge control agent, a filler, an antistatic agent, a release agent, a UV absorber, an antioxidant, an antiblocking agent, a heat-resistant stabilization agent, or a fire retardant).

<Coloring Agent>

The coloring agent containing in the toner particles of the present embodiment are dispersed in the resin above (the shell particle (A) and/or the core particle (B)). The particle size of the coloring agent is preferably not greater than 0.3 μm. When the particle size of the coloring agent exceeds 0.3 the dispersion is degraded. Thus, a desired color tone cannot be realized because glossiness is lowered.

Though a conventionally known pigment or the like may be employed as such a coloring agent without being particularly limited, from a point of view of cost, light resistance, coloring capability, and the like, for example, pigments shown below are preferably employed. In terms of color construction, these pigments are normally categorized into a black pigment, a yellow pigment, a magenta pigment, and a cyan pigment, and basically, colors (color images) other than black are toned by subtractive color mixture of a yellow pigment, a magenta pigment, and a cyan pigment.

Examples of a black pigment may include carbon black such as furnace black, channel black, acetylene black, thermal black or lamp black, carbon black derived from biomass, and the like. The black pigment may also be magnetic powders such as magnetite or ferrite. Moreover, nigrosine which is an azine-based compound such as a purple-black dye may be used alone or in combination. Nigrosine is selected from C. I. Solvent Black 7, C. I. Solvent Black 5, or the like.

Examples of a magenta pigment may include C. I. Pigment Red 2, C. I. Pigment Red 3, C. I. Pigment Red 5, C. I. Pigment Red 6, C. I. Pigment Red 7, C. I. Pigment Red 15, C. I. Pigment Red 16, C. I. Pigment Red 48:1, C. I. Pigment Red 53:1, C. I. Pigment Red 57:1, C. I. Pigment Red 122, C. I. Pigment Red 123, C. I. Pigment Red 139, C. I. Pigment Red 144, C. I. Pigment Red 149, C. I. Pigment Red 166, C. I. Pigment Red 177, C. I. Pigment Red 178, C. I. Pigment Red 222, and the like.

Examples of a yellow pigment may include C. I. Pigment Orange 31, C. I. Pigment Orange 43, C. I. Pigment Yellow 12, C. I. Pigment Yellow 13, C. I. Pigment Yellow 14, C. I. Pigment Yellow 15, C. I. Pigment Yellow 17, C. I. Pigment Yellow 74, C. I. Pigment Yellow 93, C. I. Pigment Yellow 94, C. I. Pigment Yellow 138, C. I. Pigment Yellow 155, C. I. Pigment Yellow 180, C. I. Pigment Yellow 185, and the like.

Examples of a cyan pigment may include C. I. Pigment Blue 15, C. I. Pigment Blue 15:2, C. I. Pigment Blue 15:3, C. I. Pigment Blue 15:4, C. I. Pigment Blue 16, C. I. Pigment Blue 60, C. I. Pigment Blue 62, C. I. Pigment Blue 66, C. I. Pigment Green 7, and the like.

If necessary, these coloring agents may be used alone or two or more thereof may be used in combination.

<Dispersant for Pigment>

A dispersant for pigment has a function to uniformly disperse a coloring agent (a pigment) in the toner particles, and it is preferably a basic dispersant. Here, the basic dispersant refers to a dispersant defined follows. Namely, 0.5 g of a dispersant for pigment and 20 ml of distilled water are introduced in a screw bottle made of glass, the screw bottle is shaken for 30 minutes with the use of a paint shaker, and the resultant product is filtrated. PH of a filtrate obtained through filtration is measured with a pH meter (trade name: “D-51”, manufactured by Horiba, Ltd.), and a filtrate of which pH is higher than 7 is defined as a basic dispersant. It is noted that a filtrate of which pH is lower than 7 is referred to as an acidic dispersant.

A type of such a basic dispersant is not particularly limited. Examples of the basic dispersant may include a compound (a dispersant) having a functional group such as an amine group, an amino group, an amide group, a pyrrolidone group, an imine group, an imino group, a urethane group, a quaternary ammonium group, an ammonium group, a pyridino group, a pyridium group, an imidazolino group, and an imidazolium group in a molecule of the dispersant. It is noted that what is called a surfactant having a hydrophilic portion and a hydrophobic portion in a molecule normally falls under the dispersant. Not only the surfactant but also various compounds, however, are employed as the dispersant in the present embodiment, so long as they have a function to disperse a coloring agent (a pigment).

Examples of a commercially available product of such a basic dispersant may include “Ajisper PB-821” (trade name), “Ajisper PB-822” (trade name), and “Ajisper PB-881” (trade name) manufactured by Ajinomoto Fine-Techno Co., Inc., “Solsperse 28000”, (trade name), “Solsperse 32000” (trade name), “Solsperse 32500”, (trade name), “Solsperse 35100” (trade name), “Solsperse 37500” (trade name), and the like manufactured by Japan Lubrizol Limited.

As the dispersant for pigment, a dispersant for pigment which does not dissolve in an insulating liquid (carrier liquid) is preferably selected. From this reason, the dispersant for pigment is more preferably “Ajisper PB-821” (trade name), “Ajisper PB-822” (trade name), or “Ajisper PB-881” (trade name) manufactured by Ajinomoto Fine-Techno Co., Inc. By the use of this dispersant for pigment, the desired form could be obtained with ease although the specific mechanism is not understood.

An amount of addition of such a dispersant for pigment is preferably from 1 to 100 mass % with respect to a coloring agent (pigment). The amount of addition is more preferably 1 to 40 mass %. When an amount of addition is lower than 1 mass %, dispersibility of the coloring agent (pigment) may be insufficient. Thus, necessary ID (Image Density) may not be achieved or fixation strength may be lowered. If an amount of addition exceeds 100 mass %, the dispersant for pigment in an amount exceeding an amount necessary for dispersing the pigment will be added. Thus, an excess of the dispersant for pigment may be dissolved in the insulating liquid, which may adversely affect chargeability and fixation strength of the toner particles.

One type alone or two or more types in combination can be employed as such a dispersant for pigment.

<Insulating Liquid>

The insulating liquid contained in the liquid developer of the present embodiment may be an insulating liquid having a resistance value (approximately from 10¹¹ to 10¹⁶ Ω·cm) to such an extent as not distorting an electrostatic latent image.

Further, a solvent having less odor and being low in toxicity is preferable. Typical examples of the solvent may include aliphatic hydrocarbon, alicyclic hydrocarbon, aromatic hydrocarbon, halogenated hydrocarbon, polysiloxane, and the like. In particular from a point of view of odor, harmlessness and cost, a normal paraffin-based solvent and an isoparaffin-based solvent are preferred. Specific examples of the solvent may include Moresco White (a trade name of Matsumura Oil Research Corp.), Isopar (a trade name of ExxonMobil Corporation), Shellsol (a trade name of Shell Sekiyu K.K.), IP Solvent 1620, IP Solvent 2028, and IP Solvent 2835 (a trade name of Idemitsu Kosan Co., Ltd.), and the like.

<Toner Dispersant>

The liquid developer of the present embodiment may include a dispersant (toner dispersant) which is soluble in the insulating liquid, in order to stably disperse the toner particles in the insulating liquid. A type of the toner dispersant is not particularly limited so long as it stably disperses the toner particles. In a case where an acid value of a polyester resin to be used as a resin contained in the toner particles is relatively high, a basic polymer dispersant is preferably used.

The toner dispersant may be dissolved in or dispersed in the insulating liquid. The toner dispersant is preferably added to the liquid developer in an amount from 0.5 mass % to 20 mass % with respect to the toner particles. When the amount is lower than 0.5 mass %, the dispersibility is lowered. When the amount exceeds 20 mass %, the toner dispersant captures the insulating liquid, so that the fixation strength of the toner particles may be lowered.

### EXAMPLES

Though the present embodiment will be described in further detail with reference to Examples, the present embodiment is not limited thereto. In the following, “part(s)” indicates “part(s) by mass” unless otherwise specified.

### Manufacturing Example 1

### Manufacturing of Polyester Resin

In a reaction vessel provided with a stirrer, a heating and cooling apparatus, a thermometer, a cooling pipe, and a nitrogen introduction pipe, 286 parts by mass of dodecanedioic acid, 190 parts by mass of 1,6-hexanediol, and 1 part by mass of titanium dihydroxybis(triethanolaminate) as a condensation catalyst were introduced. These were caused to react for 8 hours under a nitrogen current at 180° C. while generated water was distilled out. Next, while a temperature was gradually raised to 220° C. and generated water was distilled out, they were caused to react for 4 hours under a nitrogen current. Further, they were caused to react for 1 hour at a reduced pressure from 0.007 to 0.026 MPa. Thus, a polyester resin was obtained. The obtained polyester resin had a melting point of 68° C., Mn of 4900, and Mw of 10000.

The melting point, Mn, and Mw were measured in accordance with the method above (to be understood similarly hereinafter).

### Manufacturing Example 2

### Manufacturing of Dispersion Liquid (W1) of Shell Particles

In a beaker made of glass, 80 parts by mass of 2-decyltetradecyl(meth)acrylate, 5 parts by mass of methyl methacrylate, 5 parts by mass of methacrylic acid, 20 parts by mass of an equimolar reactant with an isocyanate group containing monomer (trade name: “Karenz MOI”, manufactured by Showa Denko K.K.) and the polyester resin obtained in Manufacturing Example 1 above, and 0.5 part by mass of azobis methoxy dimethyl valeronitrile were introduced, and stirred and mixed at 20° C. Thus, a monomer solution was obtained.

Then, a reaction vessel provided with a stirrer, a heating and cooling apparatus, a thermometer, a dropping funnel, a desolventizer, and a nitrogen introduction pipe was prepared. In that reaction vessel, 195 parts by mass of THF were introduced, and the monomer solution above was introduced in the dropping funnel provided in the reaction vessel. After a vapor phase portion of the reaction vessel was replaced with nitrogen, the monomer solution was dropped in THY in the reaction vessel for 1 hour at 70° C. in a sealed condition. Three hours after the end of dropping of the monomer solution, a mixture of 0.05 part by mass of azobis methoxy dimethyl valeronitrile and 5 parts by mass of THF was introduced in the reaction vessel and caused to react for 3 hours at 70° C. Thereafter, cooling to room temperature was carried out. Thus, a copolymer solution was obtained.

Four hundred parts by mass of the obtained copolymer solution were dropped in 600 parts by mass of an insulating liquid (trade name: “IP Solvent 2028”, manufactured by Idemitsu Kosan Co., Ltd.) which was being stirred, and THF was distilled out at 40° C. at a reduced pressure of 0.039 MPa. Thus, a dispersion liquid (W1) of shell particles (a1) was obtained. A volume-based median size of the shell particles (a1) in the dispersion liquid (W1) was 0.13 μm. The shell particles (a1) are made of a vinyl resin.

A laser particle size distribution analyzer (trade name: “LA-920”, manufactured by Horiba, Ltd.) was used to measure a volume-based median size (to be understood similarly in the following manufacturing examples).

### Manufacturing Example 3

### Manufacturing of Solution (Y1) for Forming Core Resin

In a reaction vessel provided with a stirrer, a heating and cooling apparatus, and a thermometer, 937 parts by mass of polyester resin (Mn: 2800) obtained from sebacic acid and 1,6-hexanediol (a molar ratio of 1:1), and 300 parts by mass of acetone were poured and stirred, and uniformly dissolved. In this solution, 63 parts by mass of isophoron diisocyanate (IPDI) were poured and caused to react for 6 hours at 80° C. When an NCO value of a product obtained through reaction attained to 0, 28 parts by mass of phthalic anhydride (0.19 part by mole) were poured and caused to react for 1 hour at 180° C. Thus, a core resin (b1) which is a urethane resin was obtained. The resin (b1) had Mn of 25000.

The obtained resin (b1) was used as the core resin (b1). One thousand parts by mass of the core resin (b1) and 1200 parts by mass of acetone were introduced and stirred in a beaker, to thereby uniformly dissolve the core resin (b1) in acetone. Thus, a solution (Y1) for forming the core resin (b1) was obtained. The obtained solution (Y1) for forming the core resin (b1) had a solid content of 41 mass %.

### Manufacturing Example 4

### Manufacturing of Solution (Y2) for Forming Core Resin

In a reaction vessel provided with a stirrer, a heating and cooling apparatus, and a thermometer, 38 parts by mass of polyester resin (Mn: 3500) obtained from a 2-mole adduct of propylene oxide to bisphenol A, terephthalic acid, and isophthalic acid (a molar ratio of 1:0.6:0.4), and 62 parts by mass of acetone were poured and stirred, and uniformly dissolved. Thus, a solution (Y2) for forming core resin was obtained.

### Manufacturing Example 5

### Manufacturing of Dispersion Liquid (P1) of Coloring Agent

In a beaker, 25 parts by mass of copper phthalocyanine subjected to acid treatment (trade name: “Fastogen Blue FDB-14”, manufactured by DIC Corporation) as a coloring agent (a pigment), 4 parts by mass of a basic dispersant for pigment (trade name: “Ajisper PB-821”, (manufactured by Ajinomoto Fine-Techno Co., Inc.), and 71 parts by mass of acetone were poured and stirred, to thereby uniformly disperse copper phthalocyanine. Thereafter, copper phthalocyanine was finely dispersed with the use of a bead mill. Thus, a dispersion liquid (P1) of coloring agent was obtained. A volume-based median size of the copper phthalocyanine in the dispersion liquid (P1) of coloring agent was 0.2

### Manufacturing Example 6

### Manufacturing of Dispersion Liquid (P2) of Coloring Agent

In a beaker, 25 parts by mass of carbon black (trade name: “MOGUL L”, manufactured by Cabot Corporation), 5 parts by mass of copper phthalocyanine subjected to acid treatment (trade name: “Fastogen Blue FDB-14”, manufactured by DIC Corporation), both of which were used as a coloring agent (a pigment), 8 parts by mass of a basic dispersant for pigment (trade name: “Ajisper PB-821”, manufactured by Ajinomoto Fine-Techno Co., Inc.), and 67 parts by mass of acetone were poured and stirred, to thereby uniformly disperse carbon black and copper phthalocyanine. Thereafter, carbon black was finely dispersed with the use of a bead mill. Thus, a dispersion liquid (P2) of coloring agent was obtained. A volume-based median size of the carbon black in the dispersion liquid (P2) of coloring agent was 0.2 μm.

### Manufacturing Example 7

### Manufacturing of Dispersion Liquid (P3) of Coloring Agent

In a beaker, 25 parts by mass of copper phthalocyanine (trade name: “Fastogen Blue GNPT”, manufactured by DIC Corporation) as a coloring agent (a pigment), 4 parts by mass of an acidic dispersant for pigment (trade name: “Solsperse 44000”, manufactured by Japan Lubrizol Corporation), and 71 parts by mass of acetone were poured and stirred, to thereby uniformly disperse copper phthalocyanine. Thereafter, copper phthalocyanine was finely dispersed with the use of a bead mill. Thus, a dispersion liquid (P3) of coloring agent was obtained. A volume-based median size of the copper phthalocyanine in the dispersion liquid (P3) of coloring agent was 0.4 μm.

### Example 1

### Manufacturing of Liquid Developer (Z-1)

In a beaker, 40 parts by mass of the solution (Y1) for forming core resin, and 20 parts by mass of the dispersion liquid (P1) of coloring agent were poured and stirred at 8000 rpm with the use of T.K. Auto Homo Mixer (manufactured by PRIMIX Corporation) at 25° C., to thereby uniformly disperse the coloring agent. Thus, a resin solution (Y1P1) was obtained.

In another beaker, 67 parts by mass of an insulating liquid (trade name: “IP Solvent 2028”, manufactured by Idemitsu Kosan Co., Ltd.) and 12 parts by mass of the dispersion liquid (W1) of shell particles were poured to uniformly disperse the shell particles. Then, while T.K. Auto Homo Mixer was used at 25° C. to perform stirring at 10000 rpm, 60 parts by mass of the resin solution (Y1P1) were poured and stirred for 2 minutes. Then, a liquid mixture thus obtained was poured in a reaction vessel provided with a stirrer, a heating and cooling apparatus, a thermometer, and a desolventizer, and a temperature was raised to 35° C. Thereafter, at a reduced pressure of 0.039 MPa at 35° C., acetone was distilled out from the resin solution (Y1P1) until a concentration of acetone in the liquid mixture was not higher than 0.5 mass %. Thus, a liquid developer (Z-1) was obtained.

The resin of the toner particles in the liquid developer (Z-1) had the core-shell structure including the shell resin (a1) and the core resin (b1).

### Example 2

### Manufacturing of Liquid Developer (Z-2)

A liquid developer (Z-2) was obtained by storing the liquid developer (Z-1) obtained in Example 1 for 24 hours in a thermostat bath set at 60° C. This example corresponds to a case in which annealing is performed after the manufacturing of the toner particles.

### Example 3

### Manufacturing of Liquid Developer (Z-3)

In a beaker, 40 parts by mass of the solution (Y2) for forming core resin, and 20 parts by mass of the dispersion liquid (P2) of coloring agent were poured and stirred at 8000 rpm with the use of T.K. Auto Homo Mixer (manufactured by PRIMIX Corporation) at 25° C., to thereby uniformly disperse the coloring agent. Thus, a resin solution (Y2P2) was obtained.

In another beaker, 67 parts by mass of the insulating liquid (trade name: “IP Solvent 2028”, manufactured by Idemitsu Kosan Co., Ltd.) and 9 parts by mass of the dispersion liquid (W1) of shell particles were poured to uniformly disperse the shell particles. Then, while T.K. Auto Homo Mixer was used at 25° C. to perform stirring at 10000 rpm, 60 parts by mass of the resin solution (Y2P2) were poured and stirred for 2 minutes. Then, a liquid mixture thus obtained was poured in a reaction vessel provided with a stirrer, a heating and cooling apparatus, a thermometer, and a desolventizer, and a temperature was raised to 35° C. Thereafter, at a reduced pressure of 0.039 MPa at 35° C., acetone was distilled out from the resin solution (Y2P2) until a concentration of acetone in the liquid mixture was not higher than 0.5 mass %. Thus, a liquid developer (Z-3) was obtained.

The resin of the toner particles in the liquid developer (Z-3) had the core-shell structure including the shell resin (a1) and the polyester core resin.

### Example 4

### Manufacturing of Liquid Developer (Z-4)

In a beaker, 35 parts by mass of the solution (Y1) for forming core resin, and 25 parts by mass of the dispersion liquid (P2) of coloring agent were poured and stirred at 8000 rpm with the use of T.K. Auto Homo Mixer (manufactured by PRIMIX Corporation) at 25° C., to thereby uniformly disperse the coloring agent. Thus, a resin solution (Y1P2) was obtained.

In another beaker, 67 parts by mass of the insulating liquid (trade name: “IP Solvent 2028”, manufactured by Idemitsu Kosan Co., Ltd.) and 12 parts by mass of the dispersion liquid (W1) of shell particles were poured to uniformly disperse the shell particles. Then, while T.K. Auto Homo Mixer was used at 25° C. to perform stirring at 10000 rpm, 60 parts by mass of the resin solution (Y1P2) were poured and stirred for 2 minutes. Then, a liquid mixture thus obtained was poured in a reaction vessel provided with a stirrer, a heating and cooling apparatus, a thermometer, and a desolventizer, and a temperature was raised to 35° C. Thereafter, at a reduced pressure of 0.039 MPa at 35° C., acetone was distilled out from the resin solution (Y1P2) until a concentration of acetone in the liquid mixture was not higher than 0.5 mass %. Thus, a liquid developer (Z-4) was obtained.

The resin of the toner particles in the liquid developer (Z-4) had the core-shell structure including the shell resin (a1) and the core resin (b1).

### Example 5

### Manufacturing of Liquid Developer (Z-5)

In a beaker, 40 parts by mass of the solution (Y1) for forming core resin, and 20 parts by mass of the dispersion liquid (P1) of coloring agent were poured and stirred at 8000 rpm with the use of T.K. Auto Homo Mixer (manufactured by PRIMIX Corporation) at 25° C., to thereby uniformly disperse the coloring agent. Thus, a resin solution (Y1P1) was obtained.

In another beaker, 67 parts by mass of the insulating liquid (trade name: “IP Solvent 2028”, manufactured by Idemitsu Kosan Co., Ltd.) and 6 parts by mass of the dispersion liquid (W1) of shell particles were poured to uniformly disperse the shell particles. Then, while T.K. Auto Homo Mixer was used at 25° C. to perform stirring at 10000 rpm, 60 parts by mass of the resin solution (Y1P1) were poured and stirred for 2 minutes. Then, a liquid mixture thus obtained was poured in a reaction vessel provided with a stirrer, a heating and cooling apparatus, a thermometer, and a desolventizer, and a temperature was raised to 35° C. Thereafter, at a reduced pressure of 0.039 MPa at 35° C., acetone was distilled out from the resin solution (Y1P1) until a concentration of acetone in the liquid mixture was not higher than 0.5 mass %. Thus, a liquid developer (Z-5) was obtained.

The resin of the toner particles in the liquid developer (Z-5) had the core-shell structure including the shell resin (a1) and the core resin (b1).

### Comparative Example 1

### Manufacturing of Liquid Developer (Z-6)

A liquid developer (Z-6) was obtained by storing the liquid developer (Z-3) obtained in Example 3 for 24 hours in a thermostat bath set at 60° C. This comparative example corresponds to a case in which annealing is performed after the manufacturing of the toner particles.

### Comparative Example 2

### Manufacturing of Liquid Developer (Z-7)

After 100 parts by mass of the polyester resin used in Manufacturing Example 4 and 25 parts by mass of a magenta pigment (trade name: “Symuler Brilliant Carmine 6B 410”, manufactured by DIC Corporation) used as a coloring agent (a pigment) were satisfactorily mixed by a Henschel mixer, a mixture thus obtained was melted and kneaded with the use of a co-rotating twin screw extruder having an in-roll heating temperature of 100° C. A mixture thus obtained was cooled and coarsely crushed. Thus, coarsely crushed toner A (D50: 5.2 μm) was obtained.

This coarsely crushed toner A was crushed with the use of Counter Jet Mill 200AFG (manufactured by Hosokawa Micron Ltd.). Thus, dry crushed toner (D50: 2.3 μm) was obtained. The coarsely crushed toner A was crushed under conditions that an amount of air pressure was 2.3 m³/min., an air pressure was 0.8 kPa, a nozzle diameter was 3 mm, and a rotation speed was 11500 rpm.

Then, 70 parts by mass of the insulating liquid (trade name: “IP Solvent 2028”, manufactured by Idemitsu Kosan Co., Ltd.), 30 parts by mass of the dry crushed toner A, and 1 part by mass of an N-vinylpyrrolidone/alkylene copolymer (trade name: “Antaron V-216”, manufactured by GAF/ISP Chemicals Inc.) were mixed. Thus, a liquid developer (Z-7) was obtained. This comparative example corresponds to a case in which toner particles are obtained by a dry crushing method.

### Comparative Example 3

### Manufacturing of Liquid Developer (Z-8)

After 100 parts by mass of the polyester resin used in Manufacturing Example 3 and 25 parts by mass of copper phthalocyanine (trade name: “Fastogen Blue GNPT”, manufactured by DIC Corporation) used as a coloring agent (a pigment) were satisfactorily mixed by a Henschel mixer, a mixture thus obtained was melted and kneaded with the use of a co-rotating twin screw extruder having an in-roll heating temperature of 100° C. A mixture thus obtained was cooled and coarsely crushed. Thus, coarsely crushed toner B (D50: 5.2 μm) was obtained.

Then, 30 parts by mass of the coarsely crushed toner B, 70 parts by mass of the insulating liquid (trade name: “IP Solvent 2028”, manufactured by Idemitsu Kosan Co., Ltd.), and 7 parts by mass of an N-vinylpyrrolidone/alkylene copolymer (trade name: “Antaron V-216”, manufactured by GAF/ISP Chemicals Inc.) as a dispersant were mixed by a sand mill for 24 hours. Thus, a liquid developer (Z-8) was obtained. This comparative example corresponds to a case in which toner particles are obtained by a wet crushing method.

### Comparative Example 4

### Manufacturing of Liquid Developer (Z-9)

A liquid developer (Z-9) was obtained in the same manner as in Example 1 except that the dispersion liquid (P1) of coloring agent was changed to the dispersion liquid (P3) of coloring agent to obtain a resin solution (Y1P3) in Example 1. This comparative example corresponds to a case in which an acidic dispersant for pigment is used as the dispersant for pigment.

<Evaluations>

<Measurement of Physical Values of Toner Particles>

With regard to the toner particles contained in the liquid developers in the respective examples and comparative examples, a median size (volume distribution), an average circularity, a standard deviation of circularity, and a minimum value of the circularity were measured with the use of a flow particle image analyzer (trade name: “FPIA-3000S”, manufactured by SYSMEX CORPORATION). As a flow solvent, IP Solvent 2028 was used as in the insulating liquid of each liquid developer.

A suspension was prepared by pouring 50 mg of each liquid developer in 20 g of IP Solvent 2028 to which 30 mg of a dispersant (trade name: “S 13940”, manufactured by Japan Lubrizol Corporation) was added. The suspension was subjected to dispersion treatment for about 5 minutes with the use of an ultrasonic dispersion system (trade name: “Ultrasonic Cleaner Model VS-150”, manufactured by VELVO-CLEAR).

Thereafter, using the suspension, a volume-based median size (D50) of the toner particles, circularity (a circumferential length of a circle equal to a particle area/a particle circumferential length) of each particle, an average circularity (an average value of the circularity), a standard deviation of the circularity, and a minimum value of the circularity were measured with the flow particle image analyzer above. The results are shown in Table 1.

In Table 1, a numeric value in a column of the minimum value of the circularity corresponds to a value obtained by dividing the minimum value of the circularity by the average circularity.

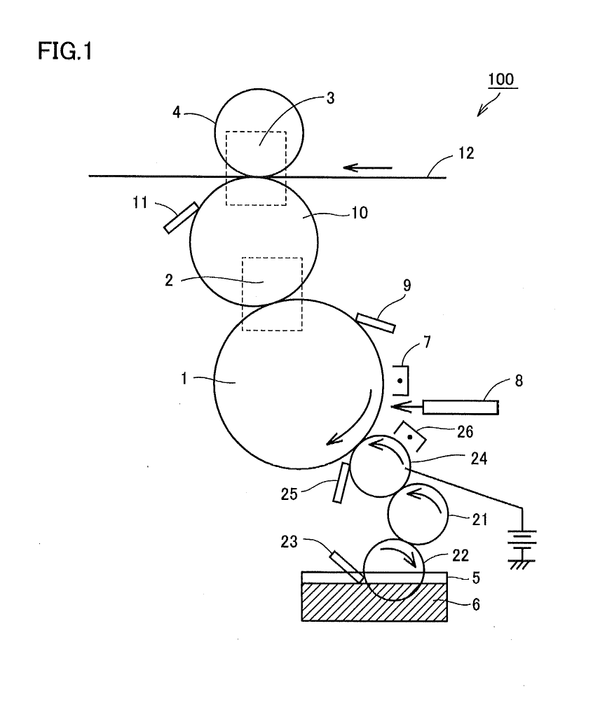

Next, the image formation apparatus illustrated in FIG. 1 was used to perform various evaluations on the liquid developers in the respective examples and comparative examples.

<Process Conditions and Outlines of Process of Image Formation Apparatus>

With regard to the image formation apparatus, process conditions and outlines of a process are as follows. In these evaluations, a single-color image formation apparatus was used, in which toner is subjected to primary transfer from a photoconductor to an intermediate transfer body, and then is subjected to secondary transfer to a recording material. However, the similar effects can be attained also in a method of directly transferring toner from a photoconductor to a recording material, and a multi-color image formation apparatus in which a color image is formed by superposing a plurality of developers on one another.

In an image formation apparatus 100, a developer tank 5 stores therein a liquid developer 6 in each of the examples and comparative examples above. Liquid developer 6 is lifted up by an anilox roller 22, and then is fed to a leveling roller 21. Redundant liquid developer 6 on a surface of anilox roller 22 is scraped off by an anilox restriction blade 23 before reaching leveling roller 21. In leveling roller 21, liquid developer 6 is adjusted so that the thickness thereof becomes even. Next, liquid developer 6 is transferred from leveling roller 21 to a developer carrier 24.

A photoconductor 1 is electrically charged in a charging unit 7, and a latent image is formed on an exposing unit 8. In response to an image of which the latent image is formed, the toner particles of liquid developer 6 are electrically charged in a developing charger 26, and then are developed on photoconductor 1. Liquid developer 6 which is not transferred to photoconductor 1 is scraped off by a cleaning blade 25 disposed on the downstream side of a developing unit, and then is recovered.

Liquid developer 6 developed on photoconductor 1 is subjected to electrostatic primary transfer to an intermediate transfer body 10, in a primary transferring unit 2. Liquid developer 6 (toner particles) carried by intermediate transfer body 10 are subjected to electrostatic secondary transfer to a recording material 12, in a secondary transferring unit 3. Liquid developer 6 (toner particles) transferred to recording material 12 is fixed by a fixing device (not illustrated), so that an image is completed in a form of a print.

Liquid developer 6 which is not transferred and remains on photoconductor 1 is scraped off by a cleaning blade 9 of an image carrier cleaning unit. Photoconductor 1 repeats the process of electrical charge, exposure and developing again, and performs the printing operation. Similarly, liquid developer 6 which is not transferred and remains on intermediate transfer body 10 is scraped off by a cleaning blade 11.

The toner particles are electrically charged with positive polarity by developing charger 26. Intermediate transfer body 10 had a potential of −400 V, a transfer roller 4 had a potential of −1200 V. A conveyance rate was 400 mm/s.

As the recording material, coated paper (trade name: “OK top coat” (128 g/cm²), manufactured by Oji Paper Co., Ltd.) was used.

<Evaluation of Cleanability>

The image formation apparatus illustrated in FIG. 1 was used to form a single-color solid (mat) pattern of the liquid developer in each of the examples and comparative examples above (10 cm×10 cm, a toner particle attachment amount: 1.1 mg/m²) on the recording material (coated paper). Upon formation of the pattern, the apparatus is stopped. A tape was applied to the intermediate transfer body on the cleaning downstream side (the downstream side of cleaning blade 11), was separated from the intermediate transfer body, and then was observed. Thus, the following three-level evaluations were conducted. The results are shown in Table 1. The used tape was “Mending Tape” (a trade name of Sumitomo 3M Limited).

A: No toner particles are attached to the tape.

B: The toner particles are slightly attached to the tape, but fogging due to residues after the cleaning does not occur at an image.

C: The toner particles are attached to the tape, and fogging due to residues after the cleaning slightly occurs at an image.

It is apparent from Table 1 that the cleanability of the image carrier of the image formation apparatus is lowered in order of A, B, and C.

<Evaluation of Transferability>

The image formation apparatus illustrated in FIG. 1 was used to form a single-color solid (mat) pattern of the liquid developer in each of the examples and comparative examples above (10 cm×10 cm, a toner particle attachment amount: 2.5 mg/m²) on the recording material (coated paper). Next, an amount of the toner particles on the intermediate transfer body before transferring was defined as X g/m², and an amount of the toner particles on the intermediate transfer body after transferring was defined as Y g/m². With regard to the amount of the toner particles on the intermediate transfer body before and after transferring, a mass was measured after the developer was recovered and the insulating liquid was dried.

Then, transferring efficiency was obtained from an equality, transferring efficiency (%)=(1−Y/X)×100. The liquid developer having the transferring efficiency not lower than 90% was represented by “A”, the liquid developer having the transferring efficiency not lower than 85% and lower than 90% was represented by “B”, and the liquid developer having the transferring efficiency lower than 85% was represented by “C”. The results are shown in Table 1. As the numeric value is large, the transferability is excellent (the transferring efficiency is favorable).

<Evaluation of Durability>

The image formation apparatus illustrated in FIG. 1 was used to form a single-color solid (mat) pattern of the liquid developer in each of the examples and comparative examples above (10 cm×10 cm, a toner particle attachment amount: 1.1 mg/m²) on the recording material (coated paper). Subsequently, the toner particles were fixed with a hear roller (170° C.×nip time: 30 msec.).

Thereafter, image density of a cyan solid portion of the obtained fixed image was measured with a reflection density meter “X-Rite model 404” (a trade name of X-Rite, Incorporated.). The measured image density was defined as initial density.

Next, 100000 pattern images similar to that described above were outputted successively at a B/W ratio of 5%, and image density (density after deterioration) was measured as in the initial density. The liquid developer in which a difference between the initial density and the density after deterioration was not greater than 0.1 was represented by “A”, and the liquid developer having the difference exceeding 0.1 was represented by “B”. The results are shown in Table 1. As compared with “B”, “A” has a small change in the developability and the transferability even after the repetitive developing. That is, “A” has excellent durability.

TABLE 1

| | Toner Particles | | | | | | |
|---|---|---|---|---|---|---|---|
| | | | Standard | Minimum | | | |
| | Median Size | Average | Deviation of | Value of | Evaluations | | |
| | (μm) | Circularity | Circularity | Circularity | Durability | Cleanability | Transferability |
| Example 1 | 1.27 | 0.92 | 0.10 | 0.87 | A | A | A |
| Example 2 | 1.22 | 0.96 | 0.05 | 0.94 | A | A | A |
| Example 3 | 1.47 | 0.93 | 0.03 | 0.90 | A | B | A |
| Example 4 | 2.13 | 0.90 | 0.10 | 0.84 | A | A | B |
| Example 5 | 2.76 | 0.91 | 0.09 | 0.92 | A | A | A |
| Comparative | 1.44 | 0.97 | 0.01 | 0.99 | A | C | A |
| Example 1 | | | | | | | |
| Comparative | 2.11 | 0.93 | 0.11 | 0.92 | B | A | A |
| Example 2 | | | | | | | |
| Comparative | 1.87 | 0.88 | 0.14 | 0.95 | B | A | C |
| Example 3 | | | | | | | |
| Comparative | 1.92 | 0.98 | 0.02 | 0.91 | A | C | A |
| Example 4 | | | | | | | |

It is apparent from Table 1 that the liquid developer in each of the examples above, wherein the median size is not smaller than 1 μm and not greater than 3 μm as a whole, the average circularity is not smaller than 0.90 and not greater than 0.96, and the standard deviation of the circularity is not smaller than 0.02 and not greater than 0.10, with regard to the toner particles, could be confirmed as a liquid developer having excellent transferability and cleanability with the size of the toner particles reduced, as compared with the liquid developer in each of the comparative examples above, wherein the conditions above are not satisfied. Moreover, the liquid developer in each of the examples above also had excellent durability, and had the developability and the transferability which are not changed so much even when the liquid developer was used repeatedly.

Additionally, when the standard deviation of the circularity is not smaller than 0.05 and not greater than 0.10 or when the minimum value of the circularity is not smaller than 0.85 times and not greater than 0.95 times the average circularity, it could be confirmed that the transferability and the cleanability were further improved.

Although the present invention has been described and illustrated in detail, it is clearly understood that the same is by way of illustration and example only and is not to be taken by way of limitation, the scope of the present invention being interpreted by the terms of the appended claims.

What is claimed is:

1. A liquid developer comprising:
an insulating liquid; and
a plurality of toner particles, wherein
said plurality of toner particles has a median size not smaller than 1 μm and not greater than 3 μm as a whole, and
in said plurality of toner particles, average circularity is not smaller than 0.90 and not greater than 0.96, and a standard deviation of circularity is not smaller than 0.02 and not greater than 0.10.

2. The liquid developer according to claim 1, wherein
said standard deviation of said circularity is not smaller than 0.05 and not greater than 0.10.

3. The liquid developer according to claim 1, wherein
a minimum value of said circularity is not smaller than 0.85 times and not greater than 0.95 times said average circularity.
